(19) United States
(12) Patent Application Publication
(10) Pub. No.: US 2002/0032677 A1
(43) Pub. Date: Mar. 14, 2002

(54) Methods for creating, editing, and updating searchable graphical database and databases of graphical images and information and displaying graphical images from a searchable graphical database or databases in a sequential or slide show format

(76) Inventors: Jeff Morgenthaler, Houston, TX (US); Arnaud Dasprez, Houston, TX (US); Blair Bouchier, Houston, TX (US); Manish Gupta, Missouri City, TX (US); Andre Pfanz, Houston, TX (US); Matthew Davis, Houston, TX (US); Kevin Musgrave, Houston, TX (US)

Correspondence Address: HOWREY LLP, ATTORNEYS AT LAW, 750 Bering Drive, Houston, TX, 77057-2198, US

(21) Appl. No.: 09/882,860

(22) Filed: Jun. 15, 2001

Related U.S. Application Data
(63) Continuation-in-part of application No. 09/516,901, filed on Mar. 1, 2000.

(51) Int. Cl. G06F 17/30; G06F 15/16

(52) U.S. Cl. 707/3; 709/217; 707/101; 707/104.1; 345/733

(57) ABSTRACT

The current method invention captures the spirit of the Internet by focusing on maximizing the Internet's utility. Specifically, the current invention seeks to offer an improved and streamlined method of searching and pinpointing information available in the abundance of the Internet's publicly available information. To accomplish this motive, the current invention captures static screen shot images of website homepages; converts these screen shots into compressible files and into different sizes; constructs and categorizes these screen shots into a relational database; allows search queries into the relational database; and displays these screen shots in various sizes within a slideshow format or business directory format. By constructing a searchable graphical database of static homepage screen shots and displaying query results in an easily navigable graphical format, the current invention allows Internet users to conduct faster, more substantive and informed Internet searches, thereby maximizing the Internet users' time, experience, privacy, and security. The current method invention also allows for improved methods of generating advertising revenue.

### CROSS-REFERENCE TO RELATED APPLIATIONS

The subject matter of the instant invention is related to, and a continuation-in-part from, copending and commonly assigned Non-Provisional U.S. patent application Ser. No. 09/516,901, filed on Mar. 1, 2000. The disclosure of the identified application is incorporated by reference in its entirety.

### BACKGROUND OF THE INVENTION

The present invention embodies an improved method for significantly improving the Internet's searchability and usability. Specifically, the present invention provides improved methods for retrieving Internet information, databasing and indexing Internet information, and packing the Internet information. Furthermore, the present invention provides an improved method of presenting information and advertisements on the Internet, thereby enhancing Internet users' experiences through process streamlining and removal of obtrusive Internet subject matter. The present invention achieves these utilities by providing for a new method of creating a searchable graphical database and presenting search query results in a graphical format that is viewed as a slide show.

The Internet, a global communication network for computers, interconnects individual computers and networks of computers to each other to allow for information and file sharing. By offering an electronic communication medium for individuals, businesses, organizations, and institutions, the Internet has become a significant component for these users in accessing the global marketplace. The interconnectivity the Interest offers allows users to utilize the Internet for such purposes as education, entertainment, business, tracking, research, and other various functions.

The Internet's primary mode of utilization occurs through the viewing of websites. A website consists of files written in hypertext mark-up language (“HTML”) that codes for the website's displayed images and textual information. These HTML files make up the website's homepage, or the initial page Internet users view when accessing a website, as well as the website's remaining webpages or subsequent pages within a website that Internet users can link to and view. A website and its HTML files are located on individual server computers and networks that are connected to the Internet. Thus, any Internet user from anywhere in the world can access information contained in any website located on a server computer connected to the Internet.

To traffic the data flowing on the Internet, websites are assigned uniform resource locators (“URL's”), which are addresses to websites' homepage and webpages. Each website homepage and webpage is assigned a specific URL. By typing a URL in an Internet browser, such as Microsoft's Internet Explorer or Netscape's Netscape Navigator, Internet users will be directed to a website's specific server computer and will be able to view the website's content.

The Internet's interconnectivity offers an alternative method for Internet users to navigate the Internet and view websites. Because websites can incorporate URL links, or Internet links to other website addresses, within its HTML code, these links can be displayed within the individual websites. Thus, rather than typing individual URLs into the Internet browser, Internet users can merely select the desired link on the existing website to access and view content from a new website. The importance of this linking technology cannot be understated, as it offers a means to generate advertising revenue, to monitor Internet user characteristics and tendencies, and to monitor Internet traffic and utilization.

As global Internet utilization and popularity increases and as individuals, businesses, organizations, and institutions develop improved methods of Internet utilization, the number of websites connected and the amount of information offered over the Internet can only correlatively increase. Even at the present state, the Internet offers a myriad number of Internet websites to view. The amount of websites and information offered over the Internet poses a problem to all Internet users—pinpointing specific websites that offer worthy and relevant content for users.

Current technology offers Internet users a method for searching the Internet to pinpoint specific websites matching an Internet user's interest. This technology takes the form of a search engine. Examples of search engines include Yahoo.com, Google.com, Lycos.com, Altavista.com, and others. All current search engines are textually based technologies, as all functions of these search engines rely on a textual mode of information and retrieval. The operational method for these search engines begins internally with the search engines' hardware and programming. Search engines contain shotbot (also termed “spider”, “bot”, or “crawler”) programming that automatically canvasses designated or random websites and their webpages. These shotbot programs read websites and webpages over the entire Internet, targeting specific words, URLs, code, or other symbols within websites' and webpages' HTML programming. Upon finding the targeted information, the shotbot retrieves the text-based information and links the corresponding URL back to the search engine.

As the search engine accumulates URL's and text-based information the shotbot programming retrieved, another search engine programming component organizes this data into a content index or catalog. These catalogs organize URL's according to designated categories, such as topic, key word, or subtopic. The catalog is arranged within a database in a tree directory fashion where each category is a directory or subdirectory containing the website or webpage and pertinent information. The websites and webpages are categorized with their corresponding URL and a brief textual depiction of the website's or webpage's specific content recognized by the shotbot. As a search engine's shotbot programming performs its function, millions of websites and webpages are scanned and categorized. Search engine content indexes typically contain millions or billions of categorized websites and webpages. However, because websites are often related to multiple topics or subtopics and because each website can therefore be listed in numerous categories, the tree directory format of existing search engines can exponentially increase the database size.

The final component in a search engine's function involves the Internet user. An Internet user accesses the search engine website through a user interface or Internet browser. The search engine website typically contains a text box for the Internet user to type in a term or subject matter the user is interested in viewing over the Internet. Presuming the Internet user correctly spells the search term correctly, this aspect of an Internet search is termed a “search query.” Alternatively, most search engine websites display a directory of topics and subtopics for the Internet user to link to in the event the Internet user does not specifically know the exact content desired. Such topics or subtopics may include news, sports, entertainment, and many other categories. When an Internet user makes a search query or selects a topic or subtopic link, the search engine accesses its content database and searches the content index for websites and webpages that match the search query terms or topic link. These search terms and topics may be located within a website or webpage URL or within the brief textual description of the website or webpage. The search engine then retrieves the websites and webpages matching the text or topic query and displays the results to the Internet user.

Current search engines display retrieved websites and webpages matching an Internet user's text or topic query in a textual list format. These textual lists may contain the website or webpage name, the corresponding URL for the Internet user to link, and/or a brief textual phrase describing the match between the website or webpage and the search query or topic. Retrieval lists may contain a varying number of websites and webpages depending on the number of websites and webpages matching the search query. The retrieved list is often displayed to the Internet user in tables ranging from ten to twenty or more links, depending on the specific search engine. Internet users have the option of viewing the remaining links by linking to the next group of retrieved websites and webpages, continuing until the search engine displays the last retrieved link.

Internet users wishing to view a retrieved website or webpage may select or click a mouse or pointing device on the URL link from the retrieval list. The link selection will direct the Internet user's browser interface to the selected website or webpage and display or download the website or webpage. The Internet user may then navigate though the website to determine its desirability. If an Internet user does not deem a website or webpage relevant to the user's preference, the Internet user may return to the search engine by commanding the Internet browser back to the search engine's retrieval list to the display prior to when the user linked to the website or webpage. The Internet user may then continue with the Internet search or start a new query on a different text or topic search.

By offering Internet users a portal to the Internet and directing Internet users to websites and webpages specific to the users' interests, search engines generate revenue through advertising and linking royalties. These forms of revenue are generated primarily through banner ads displayed on the search engines' websites. Revenue is generated based on a number of variables, which include location, size, number of times queued within the website, and number of click-throughs. Click-through is a term designating the number of times Internet users access an advertising website through a search engine website. Offering banner ads to be displayed to specific, targeted Internet users based on users' search query terms or topics can also generate advertising revenue. Revenues from banner ads and linking royalties can be substantial for popular search engines.

Despite search engines' seeming utility as a portal to the Internet, current Internet search engines and technologies are time consuming for the Internet user and have shortcomings. The primary shortcoming of existing search engines results from the text format for listing query matching websites and webpages. The brief textual phrase displayed alongside the URL link to provide information for the website or webpage oftentimes lacks sufficient information for Internet users to determine the relevance of the link. Internet users must actually visit individual websites and webpages to make any determination on relevance. Used in this manner, search engines force Internet users to search the Internet in a flip-forward-flip-backward method as Internet users repeatedly go from the search engine website to a prospectively relevant link then back to the search engine to find other links. This method consumes time and is very cumbersome. Furthermore, the flip-forward-flip-backward method may hinder Internet users' security and Internet navigation. Because Internet users are relatively unaware of the content of websites or webpages they are linking to from a search engine, links can often contain offensive content, can prevent the users' browsers from returning to the search engine, can expose the Internet users' computer to harmful viruses and programming, and can bring up irritating pop-up windows, or windows that automatically open and display Internet content of the hosting website's choosing on the users' systems. All these harmful and irritating effects of blindly linking to websites retrieved from a query cannot be prevented on current search engines. Undoubtedly, these effects can create unpleasant experiences for Internet users.

In addition to the shortcomings of the textual display of query results, the advertising banners may also create unpleasant experiences for Internet users. Primarily, banner ads prominently displayed on search engines in the viewer display may be a distraction to the Internet user. The banner ad contents may be totally irrelevant to the Internet user's search and personal tastes. The banner ad content may contain offensive or inappropriate materials the Internet user would care not see. Additionally, advanced HTML programming to make banner ads more flashy and appealing may require additional time to be downloaded and displayed, thus, consuming more of the Internet users' time. The advertising banners' obtrusive nature can often be very frustrating for Internet users.

Current banner advertising modalities also pose overvalued results for advertisers. Companies currently purchase display space from the search engine originating company in the form of stationary banner ads, which are displayed in a strip of specific area within Internet users' browser windows. By current design, search engines require users to scroll up and down the Internet browser's window to view the entire list of query results. Clearly, as Internet users scroll up and down the search engine website, the banner ads companies have purchased are quickly removed from the users' display. This practical result reduces the effective time banner ads are displayed to users and reduces the likelihood that an Internet user will link to the advertised website. Companies, therefore receive less than their value in paid advertising on search engines, as their banner ads are typically viewed for a fleeting amount of time when users scroll through the search engine website. The combined disadvantages of current search engine technology to Internet users and advertisers make a more effective method of Internet search technology more desirable.

Technologies are currently being developed in an attempt to improve existing search engine technologies and enhance Internet users' experience. These developing technologies focus on a method of presenting query results on a graphics-based display in lieu of the traditional text-based listing. Websites such as eTour.com (“eTour”), iReview.mac.com (“iReview”), Fish4It.com (“Fish4It”), Ditto.com (“Ditto”), and most recently X2Search.com (“X2Search”) and Girafa.com (“Girafa”) are currently developing these graphics-based technologies. eTour allows users to conduct Internet searches based on user registration to the website and a focused selection of various topics of interest on the registration form. eTour then displays websites relevant to users' topic interests in a slideshow format. The format causes a new Internet browser to open and download each new website. To download a website entails connecting to a website's main server connected to the Internet and allow the website HTML programming to load into an Internet end user's computer browser. Thus, for every website returned as a match for the users' topic interests, a new Internet browser is opened and displayed. To conduct subsequent Internet searches, users must re-register and check relevant topics of interest each time an Internet query is desired. eTour's primary intent seems not to provide a novel way for conducting Internet searches, but rather to generate a database of user characteristics that the website may use in another manner for revenues.

Although eTour provides a graphical Internet search, the website does little to improve Internet users' search experience over traditional text-based searches. By opening a new browser window for each website, eTour's slideshow format still requires users to laboriously wait for the downloading of retrieved websites and their associated HTML programming, flash graphics, audio programming, and other web programming modalities. Additionally, eTour's format does not protect user security or privacy. Without any control over which websites are presented, users are vulnerable to system-lethal viruses and programs as well as third party access to the users' personal information. The combined time consumption, potential security exposure, and the lack of user discretion over viewed content gives eTour minimal advantages over existing search technologies.

iReview offers Internet users a hybrid text-based and graphics-based search technology. Users select or provide a search topic, and iReview retrieves and displays topic-matching websites in a textual list format. Users may then select a text link from the list to bring up a new webpage displaying a small thumbnail, or snapshot, of the link's homepage and an actual subjective review from iReview. Users may then select a link to bring the user directly to the website, or users may simply return to the original search results.

iReview offers some improvement over existing text-search technologies, as the subjective review of websites offers information to users on a website's relevance to the users preferences. However, iReview does not improve upon Internet users' time consumption issue, as users are required to utilize the website in a flip-forward-flip-backward modality, linking forward to view a review and then linking backward to the original search results. Combined with download time, this modality still creates a laborious process for users. Additionally, although the thumbnail image of a selected query link provides a general idea of the linked website, the small size of the image makes the text and images illegible and difficult to discern. Thus, users do not actually get a clear understanding of a linking website's relevancy to the users' preferences. iReview offers improvements over existing search technology, however, users may still have difficulty focusing a desired Internet search.

Fish4It appears as a crude, unpolished graphics-based search engine that retrieves query-matching websites and downloads their homepages individually in the browser. Although Fish4It functions similarly to eTour, Fish4It does not display results in a slideshow format. Users conduct a search on Fish4It by typing a subject matter into a text box and depressing the “cast” icon. Depressing the “cast” icon retrieves a single matching website that is displayed in the Internet browser. The “cast” icon must be repeatedly depressed each time a user desires to view a new website match.

Fish4It's shortcomings are readily apparent in its format. Users are unprotected against lethal or annoying programming from linked websites and are exposed to Internet privacy violations. Because users are given no substantive information prior to the display of a matching website, users are left to the discretion of Fish4It's random display of query results—users have no control over which websites to link and view. Fish4It searches still consume much time for the Internet user, since single results are retrieved laboriously with each “cast” icon depression.

Ditto offers an image-based search mechanism that retrieves specific images that match a specific query topic. Users either enter or select a query topic and Ditto searches for images within entire websites that match the query topic. These matching images are thumbnailed and displayed to the user in a list or grid format, with nine, twelve or fifteen thumbnails displayed to a page. Users may scroll through the thumbnails and select any desired images. Upon selecting a desired image, the user is brought to two new Internet browsers, one displaying the actual-sized image and the other browser displaying the webpage from which the image was retrieved. To continue with the current search query or conduct a new search query, users must select the initial browser containing Ditto's website. Thus, users must follow a search modality consisting of browsing from Ditto's website to the image, then to the image's webpage, and then back to Ditto's website.

Ditto's image-based search does not offer much utility to Internet users seeking websites with relevant content. By merely offering images that match a query, Ditto does not provide users with any substantive preview of a website, the website's content or any information pertaining to the websites relevance to the users preferences. Ditto only offers the user knowledge that a website contains a single image that may correlate to a user's preference. Ditto's technology still creates a time consuming modality for Internet searches and exposes users to potential security and privacy breaches.

X2Search offers a search technology similar to a combination of iReview and eTour; however, X2Search appears incomplete in its development. X2Search users may select a topic-based search or type in a specific search preference. X2Search displays ten thumbnail images of websites relevant to the query in list format. Users can hover the mouse over the thumbnail to bring up a Java-based, intermediately sized image of the website. Users may then continue with the search to display ten new thumbnails of query results, elect to conduct a new search, or elect to view the results in a slideshow format via clicking on the “SlideShow” icon.

If users select to view the query results in slideshow format, a new browser is opened for the slideshow. The new Internet browser, either intentionally or mistakenly, is opened in a new 1024×768 pixel matrix —too large for the typical 800×600 pixel matrix viewing area. Because of the size of the new Internet browser, users cannot access the slideshow viewing controls. Within the slideshow browser, actual query matching websites are downloaded in the viewing area at a five-second viewing default rate. If users select on a website within the slideshow to actually view, users may click on the website within the slideshow. The selected website is then downloaded into the original browser containing X2Search's website and the browser containing the slideshow is removed. If users want to continue with the existing search on the slideshow, the user must re-access X2Search's website and re-view the entire slideshow up to the point where the user selected the previous query-matching website. The user will then be able to view query results not previously viewed within the slideshow.

X2Search's technology creates a confusing and time consuming method for Internet users. Because each query result is actually downloaded within the slideshow, time consumption is equivalent to the text-based search. Additionally, because X2Search appears to have databased these searchable websites in a flat-file directory format, search time is further prolonged. Internet users are also exposed to security and harmful and annoying programming breaches. The thumbnail display of query results does not offer much substantive preview for the user and requires the user to scroll up and down the browser to view matching results, effectively reducing advertising banner time. Finally, the premature technology appears to not provide a large enough directory database to offer users a variety of search results to choose from.

Girafa provides perhaps the most operational graphics-based Internet search modality among current Internet search technology. Girafa requires Internet users to download an executing software program from their website and install the program into the Internet users' individual client systems. The Girafa program, when opened, causes the Internet users' Internet browsers to divide into two frames. One frame consists of the Girafa search engine technology and the other frame displays actual Internet content. Users have the choice of closing out the Girafa frame, returning the browser display to its original mode.

Focusing on the Girafa search frame and Girafa's overall functionality, Internet users conduct an Internet search query by entering in specific search terms in the provided text box. Topic searches are unavailable unless the Internet user enters the topic term into the text box. Internet users then have the option of selecting, among the major commercial search engines, the specific search engine to conduct the Internet search query. These offered search engines include AOL, AltaVista, DirectHit, Excite, Fast, Go, Google, GoTo, HotBot, Infoseek, LookSmart, Lycos, MSN, MetaCrawler, NBCi, Netscape, NorthernLight, OpenDirectory, Raging, and Yahoo.

When the Internet user has selected the desired search engine and conducted the Internet search, the large display frame in the Internet user's browser will display the standard text listing of ten query matching results in the typical text format of the specific search engine's website—i.e. the display will be as if the Internet user actually conducted the search on the specific search engine website. The Girafa search frame will, after a brief delay, display ten thumbnails of the homepages corresponding to the ten matching text format results displayed in the larger frame. Subsequent lists of text-formatted, matching query results in the larger display frame and lists of ten homepage thumbnails in the Girafa frame can be generated by the Internet user depressing the “next” tab either within Girafa or on the actual search engine webpage in the larger frame. Based on the Girafa thumbnails, Internet users can click on the desired homepage thumbnail within Girafa to open the actual webpage from the thumbnail website containing the Internet search specific information. This new webpage will be displayed in the larger frame that originally contained the text-based search results from the original search engine. Users can then navigate through the chosen website in the larger display frame, while the Girafa frame remains with the webpage thumbnails generated from the search. Users may then have the option of continuing to link through the displayed webpages in the larger display or choose another thumbnail in the Girafa frame to view the precise webpage in the larger display. Internet users can also elect to conduct an entirely new Internet query, which would repeat the process.

Although practical in its use, Girafa's method of conducting graphics-based Internet searches still contains shortcomings. The mere size of the thumbnails offered is not substantial enough to allow users to make a substantive opinion on the website for which the thumbnail is linked. The thumbnails are displayed in such a fashion that forces Internet users to scroll up and down the Girafa frame to view the returned query matching thumbnails. This is an inconvenience for Internet users as well as being problematic for advertisers, similar to traditional text-based Internet search engines. Girafa's use of a split screen process, utilizing two frames in the browser window, removes effective desktop and browser space for users. Finally, oftentimes the thumbnail image presented in the Girafa frame is not the website or webpage linked to and displayed within the larger browsing frame—i.e. the thumbnail image does not correlate to the actual website or webpage to be downloaded.

Ultimately, although some technologies have attempted to replace traditional text-based Internet searches with a form of graphics-based search engine, all of these attempts fall short of reducing downloading time and users' time consumption. Additionally, these attempts have not reduced user exposure to third parties. Finally these attempts appear to be conducting searches of Internet websites rather than searches from a database of indexed homepage graphics. Thus, the need still exists to develop a method to streamline and improve the utility in conducting Internet content searches.

### SUMMARY OF THE INVENTION

Therefore, the present invention seeks to fulfill many objectives in creating an improved method for conducting an Internet search query via construction of a searchable graphical database comprised of captured images of website homepages. The present invention seeks to accomplish the following:

To provide a method for creating a searchable graphical database;

To provide a method of capturing frozen images of website homepages;

To provide a method of editing and compressing captured website homepage images;

To provide a method of cataloging website homepage images for rapid search and retrieval within the database;

To provide a method for manual editing of captured website homepage images and cataloguing of these images;

To provide a method for updating a searchable graphical database of catalogued website homepage images;

To provide a method for cataloguing website homepage images in a relational database format for improved search capabilities;

To provide a method for maintaining a searchable graphical database;

To provide a method for rapidly displaying database graphical queries in a sequential or slideshow format for users;

To provide a method for rapidly displaying graphical database queries without connecting to individual website computer servers;

To provide a method for conducting a graphical database search catered to users' preferences;

To provide a method for businesses to rapidly display images of products or services in a sequential or slideshow format based on a searchable graphical database;

To provide a method for offering Internet users a substantive search modality that displays websites' content without requiring actual connection to the website;

To provide a method for improving Internet user privacy, security, and experience in conducting Internet search queries; and

To provide a method for offering an Internet search modality that displays substantive content while reducing downloading time.

The primary method for fulfilling these objectives is through the creation of a searchable graphical database composed of captured images of website homepages. One aspect of the invention creates a method for automatically searching for information within databases in the public domain, retrieving information from these public domain databases, generating compressible graphical images of this information, cataloguing these images and their corresponding information inside a relational database, and maintaining and updating this searchable graphical database. One aspect of the invention also identifies steps in displaying information retrieved from the searchable graphic database in a slideshow or sequential format. The combination of a searchable graphical database consisting of captured homepage images and the manner of displaying this database information in a slideshow format allows Internet users a safer, more rapid, and substantively enhanced method of conducting Internet search queries over existing methods.

The method for achieving these objectives can be better understood by dividing the current invention into three main divisions. One aspect of the current invention's functional component is contained in the back-end technology that constructs and houses the databases and corresponding information. A middle component consists of technology that relays and bridges the back-end technology to the Internet end user. The front-end technology consists of the method for displaying and allowing the Internet user to access the information contained in the databases. Each of these three components can further be divided into individual functional sub-steps that contribute to the creation of the current invention's method.

Housed in the back-end technology are the hardware and programming architecture. In combination, these components perform many functions, the primary function of which is to create the searchable graphical database. To create the searchable graphical database, one aspect of the current invention performs such steps as utilizing a web browser to launch a series of shotbots (also called “spiders”, “crawlers”, and “bots”) that automatically scan the Internet and retrieve information on the Internet containing designated specifications. These specifications can include, but are not limited to, certain programming code, phrases or terms, images, or URLs from other websites. The shotbots access information on the websites seeking these specifications, and upon identifying qualified information, the shotbots retrieve the information back to the backend hardware and programs. The retrieved information is directed to a temporary database that transforms and edits the information into graphical content. The temporary database then merges with a permanent database to catalogue the graphical content into the searchable graphical database. Additional steps performed in the current invention's back-end component, which is the driving force behind the current invention's improvement over existing search engine technology, include freezing the graphical content into a screen shot, editing and cropping the screen shot into a viewable size, and converting the screen shot into a compressible file, such as a JPEG format, for quicker and easier retrieval and data management and improved memory and storage utilization.

The back-end component uses a relational database to catalogue the graphical information in a searchable graphical database. The relational database provides for faster data retrieval, improved storage capacity, and easier cataloguing of information compared to the text flat-file directory database format utilized by the majority of existing Internet search technologies. These advantages arise because a relational database requires data entries to be entered only one time with identifiers versus directory databases that require data entries to be entered numerous times under each folder that conceivably applies to the data entry.

The graphical information retrieved from the Internet is not arbitrary placed into the searchable graphical database. Part of the back-end technology involves a method for pre-screening and validating the graphical information prior to insertion into the graphical database. The pre-screening and validating function can be performed automatically by the programming and shotbots or manually by human editors with access to the relational database. Pre-screening and validating the graphical information includes functions such as, but not limited to, removing graphical data with offensive content, discarding graphical data representing poor-quality websites, ensuring the website screen shot is cropped to the appropriate viewing size, confirming the graphical information was successfully created, and ensuring the graphical data is properly categorized with appropriate identifiers. This editing function ensures quality of content for Internet users utilizing the searchable graphical database.

The back-end technology also provides a method for maintaining and updating the searchable graphical database. Similar to the pre-screening and validation functions, the maintenance and updating function can also be performed automatically with the shotbots or manually by database editors. Maintenance and updating include functions such as, but not limited to, activating and inactivating graphical database entries for permitting or preventing searchability, purging and discarding out-dated database entries, identifying and discarding underutilized database entries, discarding repeated entries inadvertently catalogued, discarding dead-end data entries (e.g. entries that do not lead to a website), and adding new graphical data entries if desired. The maintenance and updating functions can be performed at timed intervals, or on an as needed basis, to ensure the information contained in the searchable graphical database is current and usable.

While primarily serving as the functional component of the back-end technology, the searchable graphical database secondarily serves as the middle or bridge technology to link its database to the Internet end user. In this capacity, the current invention's technology that controls the database can perform multiple functions relating to the link between the Internet end user and the database. This linking component will serve to primarily upload (i.e. projecting data into an end user client computer) graphical information to the end user in a variety of formats. The graphical file uploading can occur as a result of a search query by the end user, as a creation of a favorites list of graphical information tailored to an Internet user's preferences, or any variety of categorical distribution of graphical files based on qualities identified in the Internet end user. The end user's preferences can be monitored via the use of a cookie, which is a strand of code placed into the end user's client computer to identify the end user and collect data regarding the user's Internet use habits like most frequently viewed websites, items purchased on the Internet, etc. Thus, by serving as an intermediate link between the searchable graphical database files and the access gained from the Internet end user, the database programming serves to (1) direct and monitor graphical information traffic flowing to and from the searchable graphical database, (2) display the graphical files in various formats catered to the end user's preferences, and (3) collect and monitor specific habits and identifying information from the individual Internet end user.

Aspects of the current invention also embody a front-end technology component that provides a method of displaying the graphical information retrieved from the searchable graphical database in a specific functional and visual format for the Internet end user. The Internet end user will access the searchable graphical database through an Internet browser (also termed a “front-end interface”) on an end user client computer. The front-end technology displays an interactive slideshow interface image within the end user's front-end interface. Internet end users can navigate the controls displayed in the interactive slideshow interface to control communication between the end user client system and the current invention's searchable graphical database. End users may conduct Internet searches, retrieve a favorites listing of graphical files, retrieve topic specific graphical files, or a variety of other navigational and customizable functions through the slideshow interface. As compressed graphical files are retrieved from the searchable graphical database, the files are quickly uploaded into the end user client computer and displayed within the slideshow interface in sequential format. End users may then navigate through the sequence of files to view desired content. With selection of a desired graphical file viewed in the slideshow, end users may then click on the image to bring up another browser providing direct access to the corresponding website and server. The method of displaying retrieved graphical files creates an advantage over existing search technology by providing a means for Internet end users to substantively view Internet content quickly and safely.

Thus, the current invention combines its three main components—the back-end technology, the middle linking technology, and the front-end technology—into a cohesive, multifunctional method of creating, editing and updating a searchable graphical database or set of databases and a method for displaying files within the searchable graphical database in a sequential or slideshow format. The display of these graphic files as embodied in the current invention can occur in various sizes, from thumbnails to the larger slideshow format as well as in a business directory format. Aspects of the current invention combine these components in order to accomplish its objectives and primarily provide Internet end users an improved method for conducting substantive, safe, and private Internet searches through the use of compressed graphical files of website homepages catalogued in a relational or searchable graphical database.

In addition to the technical and practical Internet query advantages that aspects of the current invention offer to Internet end users, the current invention allows for improved modes of generating advertising revenue based on its sequential display of captured homepage images matching an Internet search query. Upon an Internet end user's conduction of an Internet search query, the current invention displays matches in a sequential, slideshow format. Embedded within the display sequence are available advertising slots for other commercial entities to purchase and display their product or service to the Internet end user. Thus, the current invention may charge fees for these advertising slots in the sequence according to a premium for exposure time, repetitions of appearances within sequences, order in the sequence, and correlation to the Internet search query, among other factors.

In addition to the advertising revenue generated from the slideshow display, aspects of the current invention also allow for advertising premiums to be generated from the static browser display outside of the slideshow area in the end user's screen. Because the remaining screen outside the slideshow is static in the current invention, the current invention can offer text and banner advertising space to commercial entities. However, because the enabled display does not require Internet end users to scroll up and down the display screen, contrasted with current Internet search technologies, the current invention may maintain the same advertisement on the end user's display screen for longer duration. Thus, advertising premiums can be generated based on exposure time, number and duration of advertising refreshing in the display, topic or search query relatedness, re-exposure time, and number of times the advertisement created a link to the actual advertisement website.

### BRIEF DESCRIPTION OF THE DRAWINGS

FIG. 1—illustrates the core components of WSST

FIG. 2—illustrates the components of WSST's Back-End Technology

FIG. 3—illustrates the components of the Utilities Components in WSST's Back-End Technology

FIG. 4—illustrates the components and capabilities of the relational database or searchable graphical database

FIG. 5—illustrates the components and capabilities of the relational database's bridging function

FIG. 6—illustrates the example of Room102.com as one exemplary embodiment of the current invention's Front-End Interface Technology

FIG. 7—illustrates end users' choices in the manner of viewing WSST within Room102.com

FIG. 8—illustrates an example of the first screen shot slide in the sequence of screen shot slides resulting from a “Sports” categorical search query on Room102.com

FIG. 9—illustrates an example of the second screen shot slide in the sequence of screen shot slides resulting from a “Sports” categorical search query on Room102.com

FIG. 10—illustrates an example of the seventh screen shot slide in the sequence of screen shot slides resulting from a “Sports” categorical search query on Room102.com

FIG. 11—illustrates an example of the first screen shot slide in the sequence of screen shot slides resulting from a “Cancer” term-specific search query on Room102.com

FIG. 12—illustrates an example of the second screen shot slide in the sequence of screen shot slides resulting from a “Cancer” term-specific search query on Room102.com

FIG. 13—illustrates an example of the sixth screen shot slide in the sequence of screen shot slides resulting from a “Cancer” term-specific search query on Room102.com

FIG. 14—illustrates the “SlideShow Image Caching” technology of WSST's Front-End Interfacing Technology

FIG. 15—illustrates an advertising revenue generation model utilizing WSST

FIG. 16—illustrates an example of a current text-based Internet business directory

FIG. 17—illustrates the enhanced Internet business directory utilizing the current invention

FIG. 18—illustrates an industry association directory utilizing the current invention

FIG. 19—illustrates the database technology for EIBD

FIG. 20—illustrates the EIBD Practical Technology

### LIST OF ACRONYMS AND DEFINITIONS

HTML hypertext mark-up language

URL uniform resource locator

WSST website slideshow technology

BET back-end technology

SCC screen shot capturer

DLL dynamic link library

DSC data subset compilation

BEA back-end administrators

FEIT front-end interfacing technology

EIBD enhanced Internet business directory

### DESCRIPTION OF ILLUSTRATIVE EMBODIMENTS

The Internet's capacity as a communications medium for information transfer is revolutionary. Volumes of information are readily accessible across the globe from any computer terminal. Internet users have access to an abundance of information available from a plethora of sources, proving the Internet's utility. However, Internet users must also be cognizant and balance this utility with the challenge of locating information specific to individual interests and preferences. Current search technology only modestly fills this void in information searching over the Internet.

Current technology attempts to address this challenge by providing Internet users a text-based search engine, which returns links to websites that match an Internet user's search query in a textual format with minimal description regarding the websites' content. Based on these extremely brief phrases of information regarding the websites' content, Internet users are to gauge the websites' apparent relevancy to the user' preferences. This relevancy determination is often difficult, and users must often link to the specific website to assess the website's correlation to designated preferences. Based on the links these text-based search engines provide, and upon determining websites of interest, Internet users are required to link to and download the website to view the website's actual contents. Often, the linked website does not meet the user's preferences by virtue of the website's content, appearance, or any other factors. Internet users are then required to return to the text-based search engine to repeat the process again, creating a flip-forward-flip-backward method of examining Internet content.

The drawbacks of using current text-based search engines to examine Internet content are obvious. The flip-forward-flip-backward method of conducting Internet searches creates a laborious, time consuming, and confusing model for Internet users. Internet users also have no satisfactory manner to determine website relevancy prior to actually linking to a site. Because of the lack of informed decision-making when conducting Internet searches, Internet users are potentially exposed to offensive content, security and privacy breaches, obtrusive advertisements and pop-up websites, and other modalities in which websites can create an unpleasant Internet experience.

I. Website Slideshow Technology (“WSST”)

One exemplary embodiment of the present invention seeks to develop a method for graphically conducting Internet searches called Website SlideShow Technology (“WSST”). WSST gathers Internet information retrieved based on the users' preferences or specific search query and presents the information in a graphical format, whereby frozen images, or screen shots, of query-matching, website homepages will be displayed to Internet users. WSST displays these screen shots in a slideshow, or sequential, format that allows Internet users to navigate query results in an organized and sequential manner. The primary benefit of this method of graphically displaying Internet information is that WSST allows Internet users an opportunity to substantively review a website's content for relevancy prior to actually linking directly to the website. By providing Internet users an opportunity to make an informed decision prior to accessing a website, users are guarded against privacy and security breaches, offensive content and advertisements, and other threatening Internet content. Thus, WSST offers an enhanced method of conducting graphical Internet searches as an improved alternative to traditional text-based search engines.

WSST functionality offers additional advantages over existing text-based search technologies. The flip-forward-flip-backward modality offered by current text-based search technologies to conduct search queries requires a considerable amount of time as users must wait for websites, which are linked to and from the search retrieval list, to download into the users' Internet browser window. Based on the users' selectivity, the user may decide to stay on the linked website or return to the Internet search website, creating an additional re-downloading link that consumes more time. In sum, the traditional text-based search modalities create a laborious, arcane and inefficient way to find preferable Internet content by consuming substantial user time, depending on the speed of user connectivity to the Internet.

Contrastingly, as the name Website SlideShow Technology implies, the preferred embodiment of WSST presents Internet search content in a manner analogous to a viewing a slideshow of pictures. In the traditional viewing of a slideshow, slides of pictures are prepared in advanced and placed in a slide cartridge, which houses the prepared slides separately for viewing. The slide cartridge is loaded in to the slideshow projector. As users decide to view the pictures on the slides, the images contained on the slides loaded in the cartridge are instantaneously projected for individual viewing. Slideshow viewers may then navigate, advancing the cartridge forward or backward, to view specific slides of preference. By analogy, WSST prepares pre-screened, static images of slides consisting of websites' homepages. These images or slides are stored in a relational database (i.e. similar to a slide projector cartridge) where the user may retrieve the images. As a user conducts an Internet search query, these corresponding slides or images are brought into the user's Internet browser for viewing in a slideshow format, allowing the user to navigate the specific search. Because these images and slides are static and prepared in advance in a compressed format, users experience instant viewing of Internet search content sans the inefficient downloading time. Additionally, the technology of the WSST's preferred embodiment actually caches these compressed images into the end user system video display memory to further enhance downloading time. Thus, in total, the preferred embodiment of WSST will substantially improve Internet users' experience by decreasing the download time for conducting Internet searches via providing a method for instantaneously displaying Internet search query results.

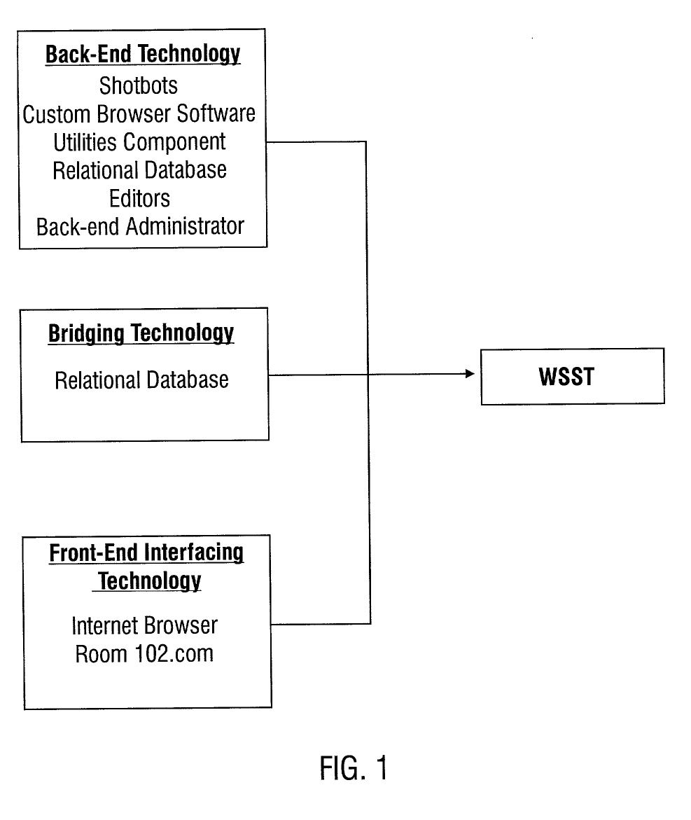

Bringing WSST to fruition requires interfacing and interacting various technologies and programming modalities, which individually can be separated and discussed. The preferred embodiment of WSST can best be understood from an in-depth description of the individual components making WSST and how these components interact in creating a functional WSST. Specifically, the description will now turn to three major areas—the back-end technology, the bridging technology, and the front-end interfacing technology, as depicted in totality in FIG. 1.

II. Back-end Technology (BET)

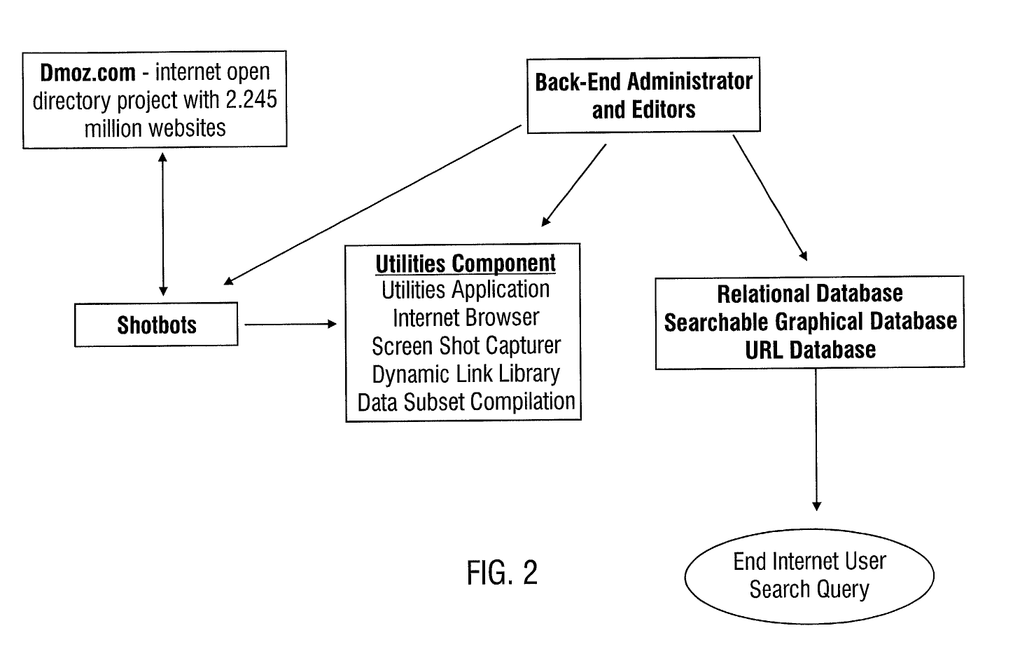

Referring to FIG. 2, the BET mainly consists of interacting hardware and programming technologies. Specifically, the BET consists of shotbots; a utilities component consisting of a utilities application, an Internet browser, a screen shot capturer, a dynamic link library, a database subset compilation; a relational database; and a back-end administrator. The components' individual functions and the manner in which they interact are discussed below.

A. Shotbots (FIG. 2)

The shotbots (also termed “webcrawlers”, “spiders, or “bots”) are a programming modality that, when released onto the Internet, search the Internet for specific information and retrieves the information to the home computer. In one exemplary embodiment, the programming utilizes thirty shotbots that are manually or automatically released in parallel onto the Internet at specific intervals. Specifically, these shotbots are released into an Internet Open Directory Project freely accessible by the public domain, for example Dmoz.com. Dmoz.com consists of a directory of 2.245 million websites, separated into 326,000 categories. Websites are voluntarily added to the Dmoz.com database with a mission to create an international, public domain of all websites on the Internet. Popular current, text-based Internet search technologies, such as AOL.com, Netscape.com, Lycos.com, and HotBot.com, use Dmoz.com to generate their individual search engine databases.

As the shotbots of the preferred embodiment of the current invention are released into the Dmoz.com database on a category by category search basis, the shotbots are programmed to recognize data bits containing specific information, including, for example, programming code, phrases or terms, images, URLs from other websites, or names of images. Upon identification of these pre-designated targets within the database, the shotbots then pull the corresponding or associated URL or website containing the specific information back to the preferred embodiment's relational database. These shotbots insert retrieved URLs into the relational database in groups of ten at a time.

In performing the seek and retrieve function of the preferred embodiment of the current invention, the shotbots also perform other various functions known as “scrubbing.” To perform the scrubbing function, the shotbots perform specific actions to the retrieved information and URLs, which include, but are not limited to:

1. Remove errors in punctuation;

2. Remove invalid characters;

3. Reduce the URLs into distinct values;

4. Imparts a time stamp on the individual URLs to denote the time of retrieval

5. Checks the URLs current status to determine if the link is still active or inactive;

6. Removes broken URLs which are inactive, contain linking error, or are nonfunctioning;

7. Detects error messages coming from the URLs due to poor HTML programming or some other factor; and

8. Directly connects the to URLs' individual servers to detect dead images on the corresponding website and to trap and flag HTML programming that may cause errors (for example programming like ShockWave, video programming, or intrusive HTML programming).

Depending on the frequency and the intervals for which the shotbots are deployed into the Dmoz.com database, the shotbots, in combination, have the capability to retrieve up to 120,000 items a day into the preferred embodiment's relational database. This volume of data collection allows WSST's preferred embodiment to generate a substantial database of URLs and website images.

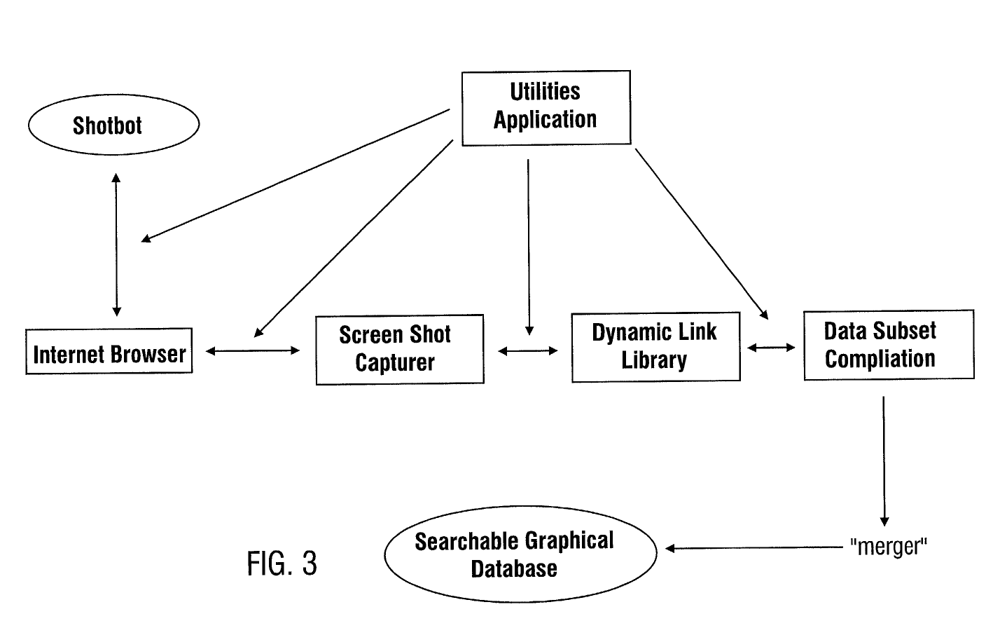

B. The Utilities Component (FIG. 2 and 3)

Referring to FIGS. 2 and 3, the Utilities Component of the preferred embodiment's BET consists of an Internet Browser, a Screen Shot Capturer, a Dynamic Link Library, a Data Subset Compilation, and a Utilities Application that monitors and directs traffic between each Utilities Component with each other and in conjunction with the URL Database (discussed below). Each of these Utilities Components are discussed in more detail.

1. Internet Browser & Shotbot Manager

The preferred embodiment of the current invention utilizes an customized Internet browser based on open-source Mozilla code. This custom Mozilla browser is utilized to browse the Internet and view and catalogue URL's retrieved by the shotbots.

The current invention's preferred embodiment also utilized an open-source shotbot manager program to monitor the shotbots' functionality and searching. The Mozilla browser and shotbot manager combination provides functional advantages, such as improved capabilities to detect shotbot and URL errors, to check date of completed code, to detect open source or uncompiled code, and to detect complete URL downloading before taking a screen shot.

2. Screen Shot Capturer (SSC) & Dynamic Link Library (DLL)

The Screen Shot Capturer is a utility application that utilizes Microsoft Visual Basic programming to function within the Mozilla browser and capture static images of the individual homepages of the direct URLs retrieved from the shotbots. The shotbots provide the SSC up to ten URLs in one particular instance for capturing. The SSC edits and manages screen shots and graphics creation to primarily capture the entire screen image of the homepages displayed in the Internet browser.

In the process of capturing a static image of the website homepages brought to the SCC, the SSC removes pop-up windows and other annoying programming modalities associated with retrieved website homepages. Because the SSC brings whatever image is centrally located in the Mozilla browser to the forefront prior to capturing the screen shot, the SSC only captures the websites' original homepage content sans the extra pop-up windows and audio programming associated with many websites. This function ensures accurate and complete capturing and compressing of the appropriate homepage content.

The Dynamic Link Library is a utility component, which preferably utilizes Lead Tools software, that works in conjunction with the SSC to edit and crop the image created by the SCC. Specifically, the DLL of the current invention's preferred embodiment trims the borders of the websites' homepages based on the size of the Mozilla browser window, removes any Internet browser components from the screen, shrinks the captured image, and compresses the image to a JPEG format, a compact file format for streamlined downloadability over the Internet. The DLL performs these functions virtually simultaneously with the SCC.

In combination, the SCC and DLL of an exemplary embodiment of the current invention can shrink and compress the captured screen shots to be displayed in three dimensions, based on the desired specifications. To maintain high resolution, the screen shot can be compressed and sized to a 380×272 pixel matrix. For faster compression and transmission speed while maintaining adequate resolution, dimensions of 300×400 pixels can be utilized. Finally, for the fastest compressions and fastest transmission speed, but with least amount of resolution, screen shots can be sized to thumbnail images of 90×125 pixels. One preferred compression and size format for the current invention is 380×272 pixels to maintain a resolution and screen shot image that retains 75% quality of the actual homepage image.

3. Data Subset Compilation (DSC)

Once the screen shots have been captured, sized, and compressed, the preferred embodiment of the current invention channels the compressed files and their corresponding URL links into a Data Subset Compilation. The DSC houses these files for preliminary access or editing prior to addition into the searchable graphical database of URLs. Eventually, the preferred embodiment will merge the compressed files within the DSC into the URL relational database via the shotbot single merge function.

4. Utilities Application (Application)

The Utilities Application of the current invention's preferred embodiment utilizes Allaire Cold Fusion, HTML, and/or Java script programming to bridge the various Utilities components to each other as well as to the URL searchable graphics database. Specifically, the Application manages the information exchange between the various components and manages the timing and activation of these components in performing their various functions. Additionally, this programming determines the shotbots' activities between the URL database and the shotbot manager and records necessary adjustments to manage dataflow.

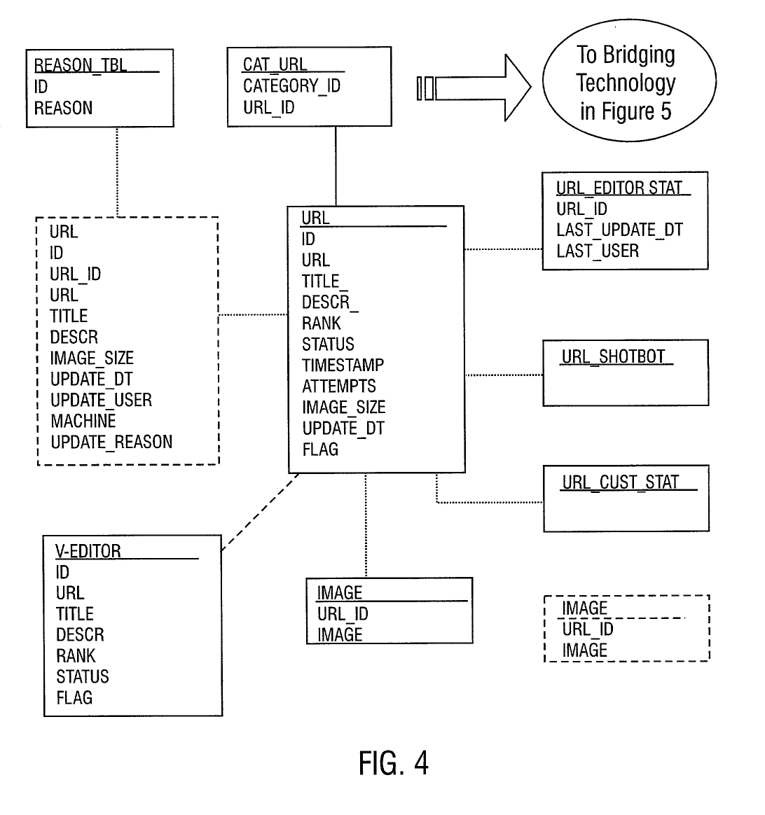

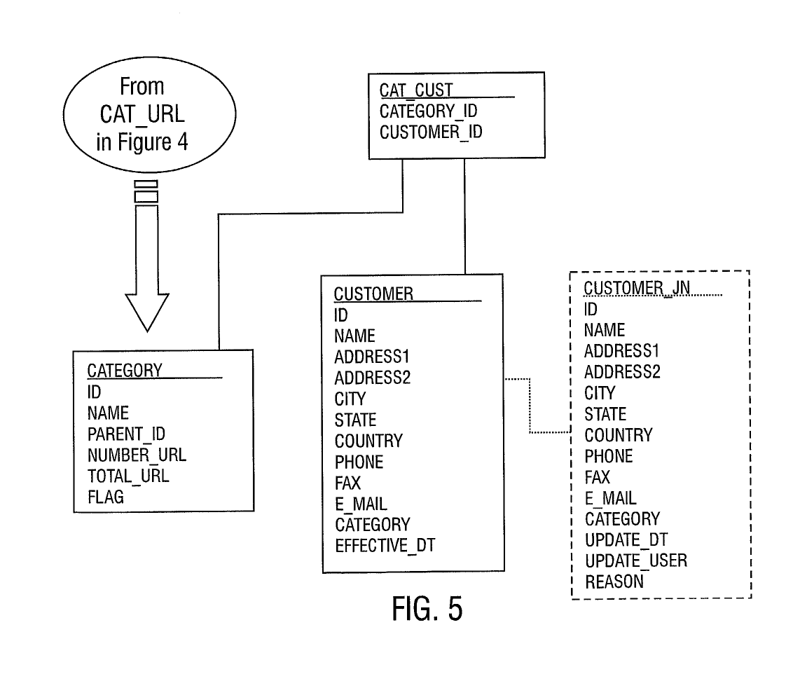

C. Relational Database (Also Termed “URL Database”, “Searchable Graphical Database”) (FIG. 4)

Referring to FIG. 4, the current invention's preferred embodiment of the relational database utilizes Oracle 8.i and binary large object (BLOB) programming to catalogue the compressed screen shots for rapid retrieval and presentation. The relational database is constructed by listing the URL's and their corresponding screen shots in a partitioned URL Table. As these URL's and screen shots are catalogued into this URL Table, associated information is also listed with each URL, such as an identification number, the linking URL, a title, a description, the URL's rank, the URL status as active or inactive, a timestamp designating cataloging time, attempts to retrieve the URL, the image size of the screen shot, the last time the file was updated, and a flag to notify editors of issues related to the URL. The second facet in constructing the relational database is creating a Category Table that contains individual category URL's to direct users to specific category topics, category identification numbers, and corresponding URL identifications numbers.

The relational database's utility is promulgated by its advanced search and retrieval functionality. As queries are made to the relational database, searches of the URL Table and Category Table are executed, via a hierarchical relationship, for query matches. As matches from both categories are identified, a Matching Matrix is constructed for the query in which URLs and Categories with higher matching correlation are selected for the query retrieval of URLs in the searchable graphical database. Thus, these URLs and their corresponding screen shots can be displayed.

The current invention's preferred embodiment of utilizing a relational database provides significant searchable speed advantages over the tree directory-based or flat file text databases of currently existing text-based and graphics-based search technology. Current search technologies utilize a tree directory or flat file text-based cataloging system, whereby various folders and sub-folders are created for various topics and sub-topics. Each URL that corresponds with a topic and/or sub-topic is sequentially catalogued into the appropriate folder and/or sub-folder in a “flat” format. Thus, throughout the entire tree directory or flat file text-based catalogue, the same URL can appear numerous times with all associated topics and sub-topics related to the URL. Because of the analogous tree and branch structure of the directory-based catalogue, when a query is conducted, the databasing program must explore each topic and sub-topic folder individually to find matching URLs, thereby creating overlapping functionality and consuming substantial amounts of time.

In comparison, the current invention's preferred relational or directory-based graphics database records each category and each URL one time, substantially reducing the amount of storage capacity and space. When searches are conducted within the relational database, the database programming is only required to scan each category and URL one time to create the Matching Matrix from which results are obtained. Because there is no overlap in functionality, the relational database drastically reduces the time needed to conduct a search on the URL database, offering tremendous speed advantages. Additionally, the relational or directory-based graphics database structure increases maintenance and editing efficiency as URLs and categories need only be updated and checked once.

In addition to the Category and URL Tables in the relational or directory-based graphics database, the searchable graphical database also houses other various tables to enhance database usability and functionality. The Editor Table allows editors to view editing information, including URL identification, name, title, description, rank, status and flags. The Image Table offers information on corresponding screen shots, including the URL identifications and the image. The Customer Statistics Table discloses information on customer statistics. The Shotbot Table provides information regarding shotbot usage. The Editor Statistics Table offers statistical information regarding editor usage, including the URL identification number for the URL edited, the last time the URL was updated, and the last user to edit the database. Finally, Back-up Tables are created to provide back-up data in the event the relational database is compromised in any fashion. The Back-up Tables are denoted in FIG. 4 as URL_JN, which offers backup to the URL Table, and IMAGE_BI, which backs-up the Images Table.

Ultimately, the preferred embodiment of the current invention offers a method to utilize existing technological components to construct a relational or directory-based graphics database of captured screen shot images with their corresponding URL's to create an improved and novel method of conducting and displaying Internet searches.

D. Back-end Administrators (BEA) of WSST

In addition to the preferred technological components embodied in aspects of the current invention, critical to the current invention's functionality is the ability to allow human intervention to assist in managing dataflow and database creation. Referring back to FIG. 2, one exemplary embodiment allows for Back-End Administrators to access the various components of the invention to edit and utilize information and websites generated by WSST in constructing the relational database. Specifically, the BEAs will interface with the searchable graphical database to perform various utility functions based on subjective discretion and judgment. Such various functions the BEAs may perform include, but are not limited to:

1. Deleting unused, offensive, and/or inappropriate URLs from the database; and

2. Determining appropriate and successful capturing, editing, and cropping of captured screen shots.

These various functions BEAs perform can occur at regular intervals or arbitrarily in the current invention's preferred embodiment.

III. Bridging Technology (FIG. 5)

Although the relational database primarily serves as the core BET component, in the preferred embodiment of the current invention, the relational database secondarily serves as the Bridging Technology between the searchable graphical database and the Internet user at the user interface. As the Bridging Technology, the relational database monitors queries placed into the searchable graphical database and records user data from individual users accessing the database.

Referring to FIG. 5, the relational database monitors and activates a search query into the searchable graphical database by utilizing a Category Table that identifies information, such as the URL identification, name, parent identification number, the URL number in the category, the total number of URLs in the category, and whether the URL is flagged for editing notification. With this information, the relational database can channel URLs corresponding to categorical queries to the user interface.

Again referring to FIG. 5, the relational database monitors user data with the Category-Customer Table and Customer Table. The Category-Customer Table matches specific query categories to specific users and records this information with the customer identification number and category identification number. The Customer Table provides the relational database with personal information on individual users by recording the user's identification number, name, address, telephone and fax numbers, email address, category, and effective downloading time. The back-up data for the Customer Table is recorded in the CUSTOMER_JN Table.

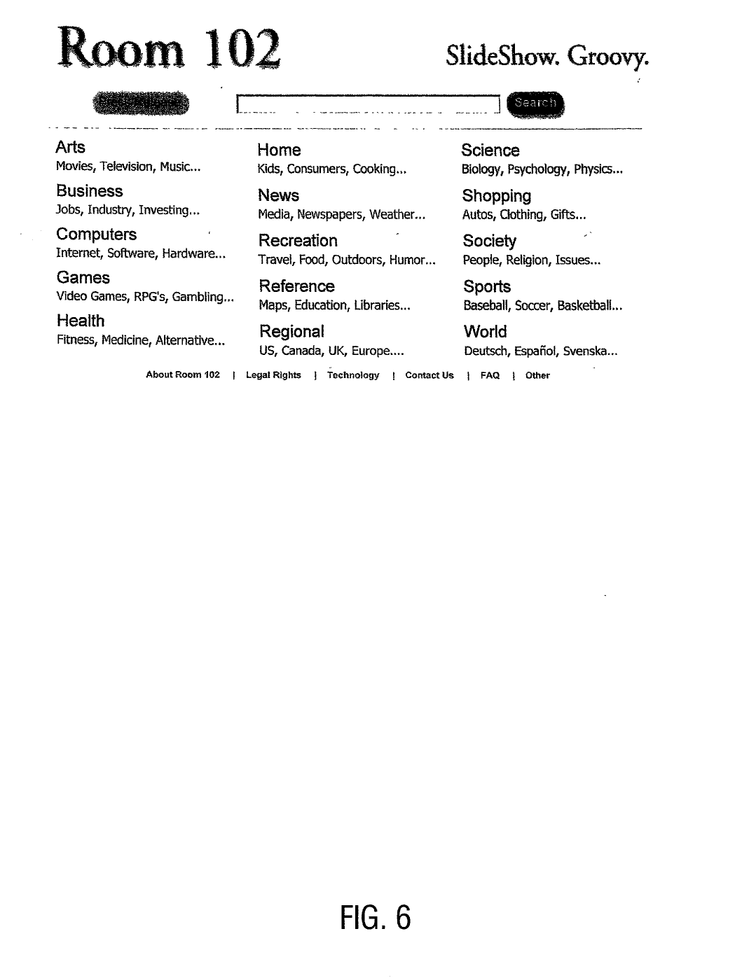

IV. Front-end Interfacing Technology (FEIT) (FIGS. 6 through 13)

In the preferred embodiment, Internet end users wishing to conduct a search query of the current invention's searchable graphical database will access the database through the present invention's Front-End Interfacing Technology, which presents search query results in the SlideShow format. Internet end users will access the searchable graphical database via Internet browsers on their respective end user systems and preferably conduct searches on Room102.com. The FEIT consists of the various functions and capabilities concentrated in the dynamics of using Room102.com.

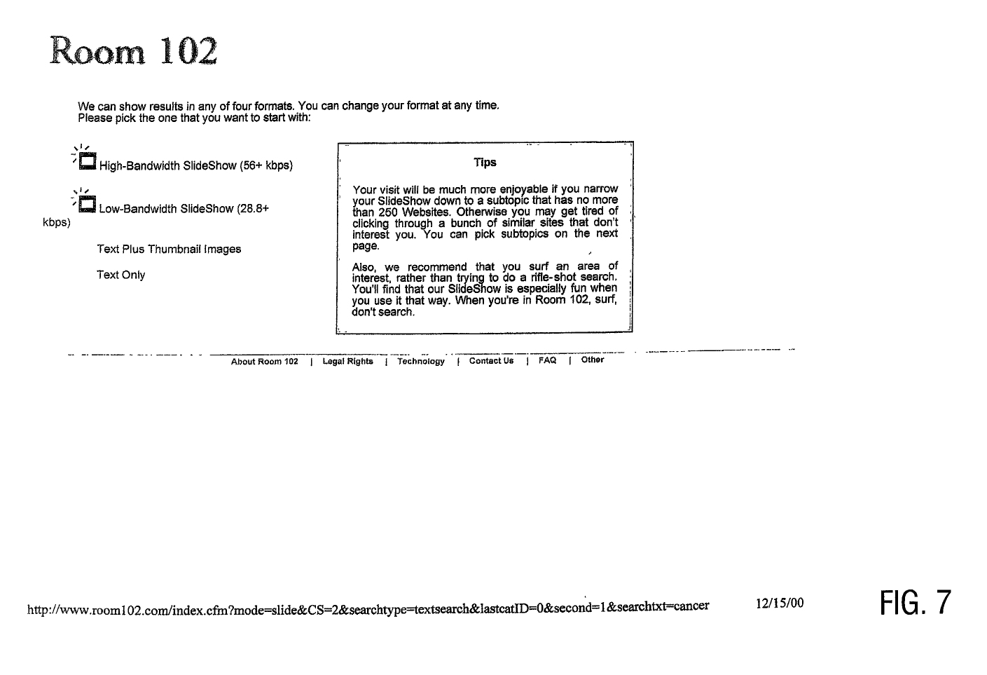

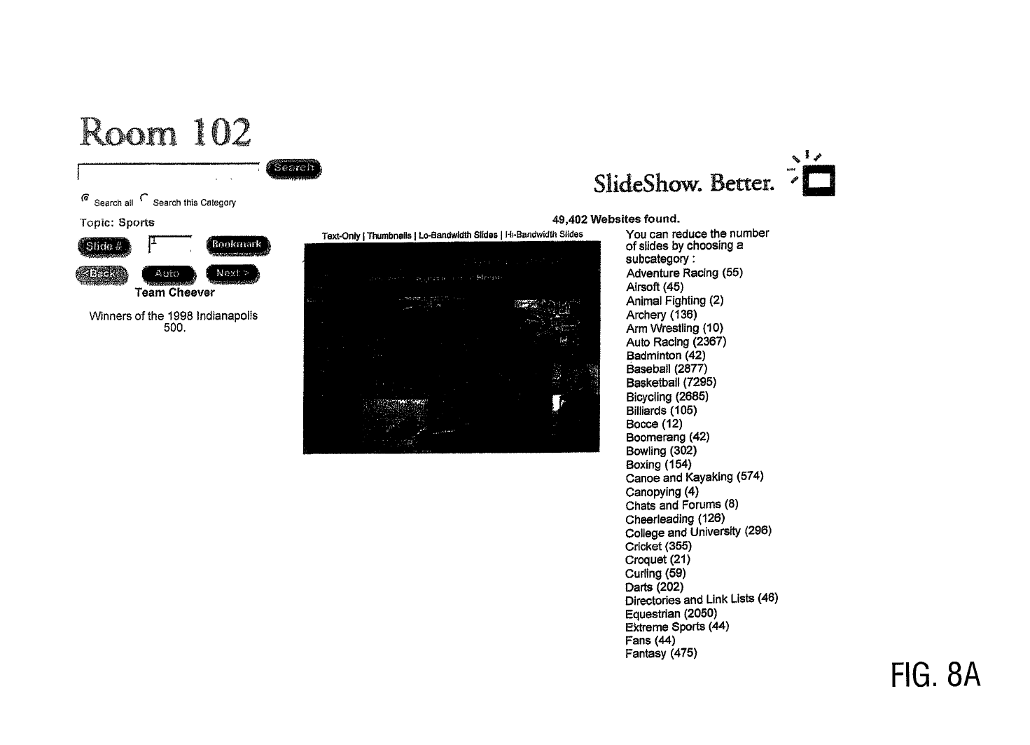

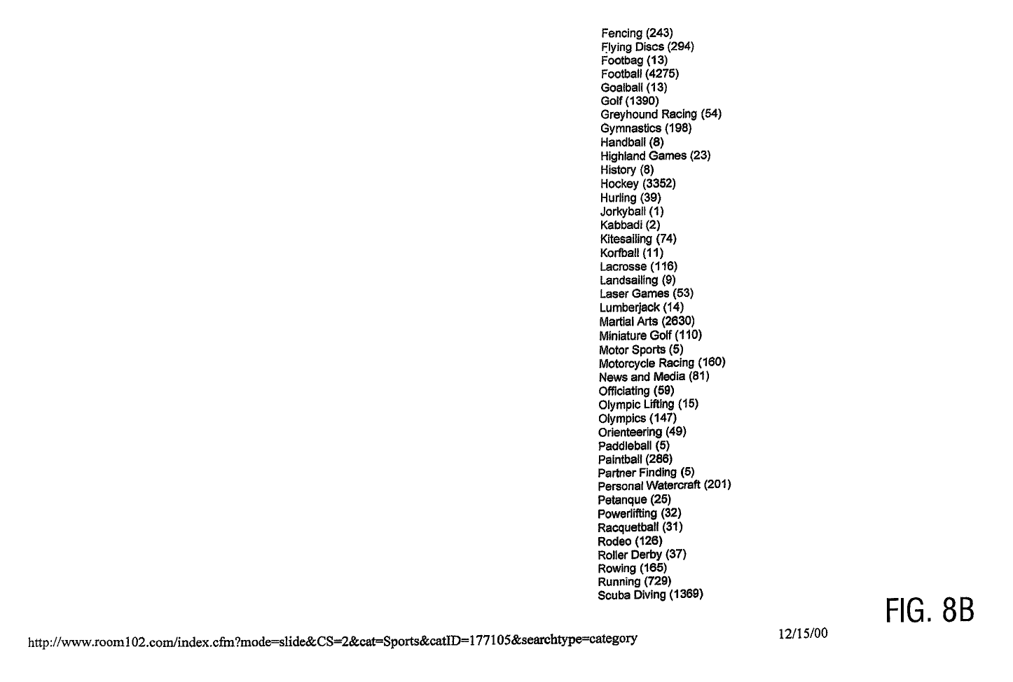

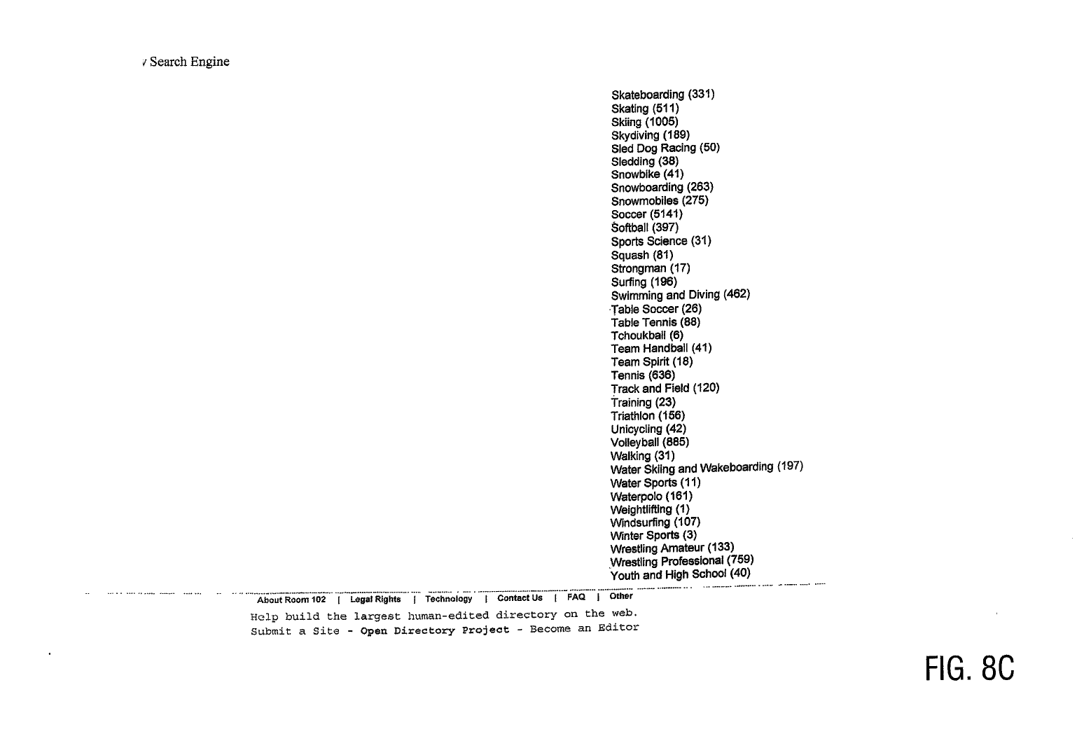

Referring to FIG. 6, as end users access Room102.com to conduct an Internet query, end users will be provided an option to conduct a categorical or sub-categorical search, as depicted by the category links (ex: Arts, Business, Computers, etc.), or a term or phrase specific search via typing a search term or phrase in the search entry box. Regardless of whether the end user conducts a categorical search or a term search, the FEIT will present a screen similar to FIG. 7 with either choice. Referring to FIG. 7, end users have four options on the manner in which the WSST will be displayed, depending on the end user's Internet connection speed. End users have available a full-sized, high- and low-bandwidth SlideShow, thumbnail results with text, and a text-only search format. Based on an end user's selection of manner to view a graphical search query, the user will then be able to view query matching results in a slide show format as shown in FIGS. 8 though 13.

Referring to FIGS. 8 through 10, end users conducting a topic or categorical search query, in the preferred embodiment, will be presented a screen similar to FIG. 8. A closer examination of the example portrayed in FIG. 8 reveals that, in this instance, a topic search under the “Sports” topic was conducted. The screen shot slide in FIG. 8 is centrally evidenced as the “Team Cheever” homepage, the first screen shot in this category. Thus, end users' are clearly offered a manner to substantively review a website's homepage content without having to directly connect to the website, offering a substantially improved method of conducting Internet queries. FIG. 8 also demonstrates that the preferred embodiment of the current invention, under a categorical search, will also offer sub-categorical searches, as evidenced by the subcategories listed on the right column of FIG. 8. End users may select a more specific subcategorical search more suited to their search preference by linking the subcategory. Upon the selection of the subcategory, the preferred embodiment of the current invention will display to the end user a new screen shot of the first graphical search result for the selected subcategory.

Again referring to FIG. 8, the current invention's preferred embodiment offers the end user a means to view graphical search query results in a slideshow format. Focusing on the control tabs on the left of FIG. 8, users are given the slide number of the current screen shot being viewed, in this instance slide #1. End users may elect to bookmark this screen shot, or designate a shortcut within their browsers to rapidly return to the current slide in a subsequent Internet search session. End users may elect to click the “Next >” tab to proceed to the next search relevant screen shot in the slide show sequence. If the user is not on the first slide of the sequence, the end user may select the “<Back” tab to return to the most previously viewed screen shot slide. If end users select the “Auto” tab, the screen shot slide show will proceed forward sequentially and automatically at a predetermined time delay, preferably ten seconds. To jump in advance to a specific desired screen shot slide, end users may enter a specific slide number in the text box located between the “Slide #” and “Bookmark” tabs; select the “Slide #” tab; and immediately proceed directly to the screen shot slide located at the desired slide number in the sequence. Thus, the preferred embodiment of the current invention provides a new manner for Internet users to conduct graphical search queries in a slide show format.

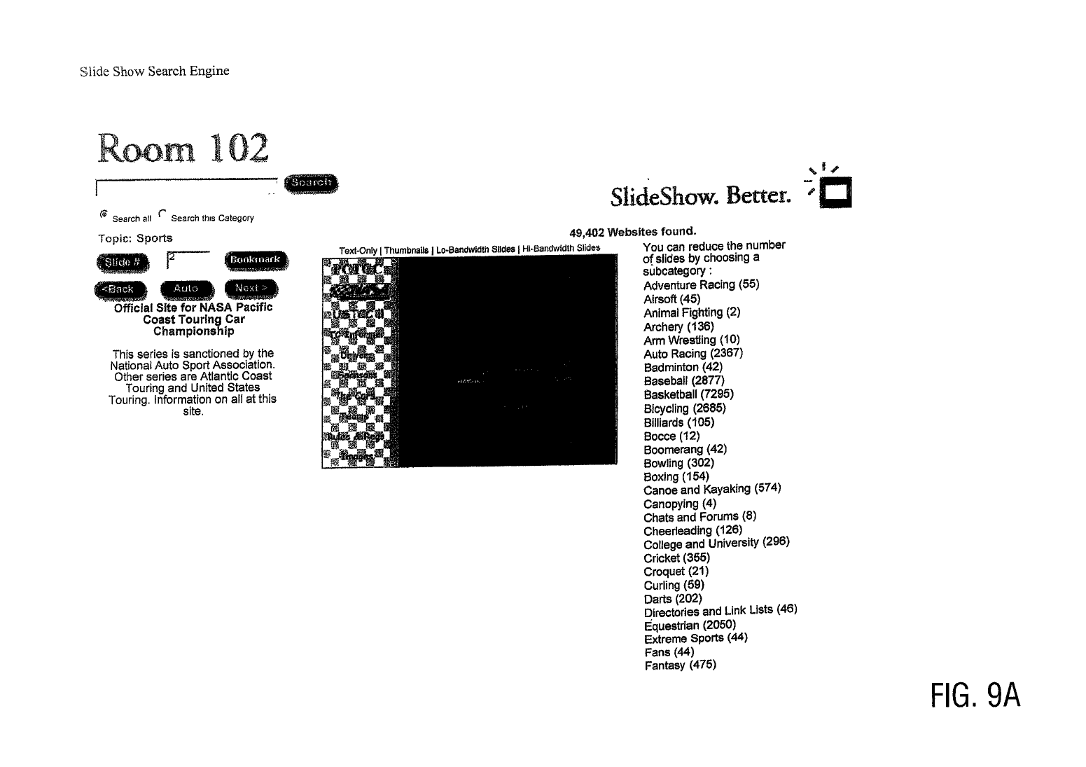

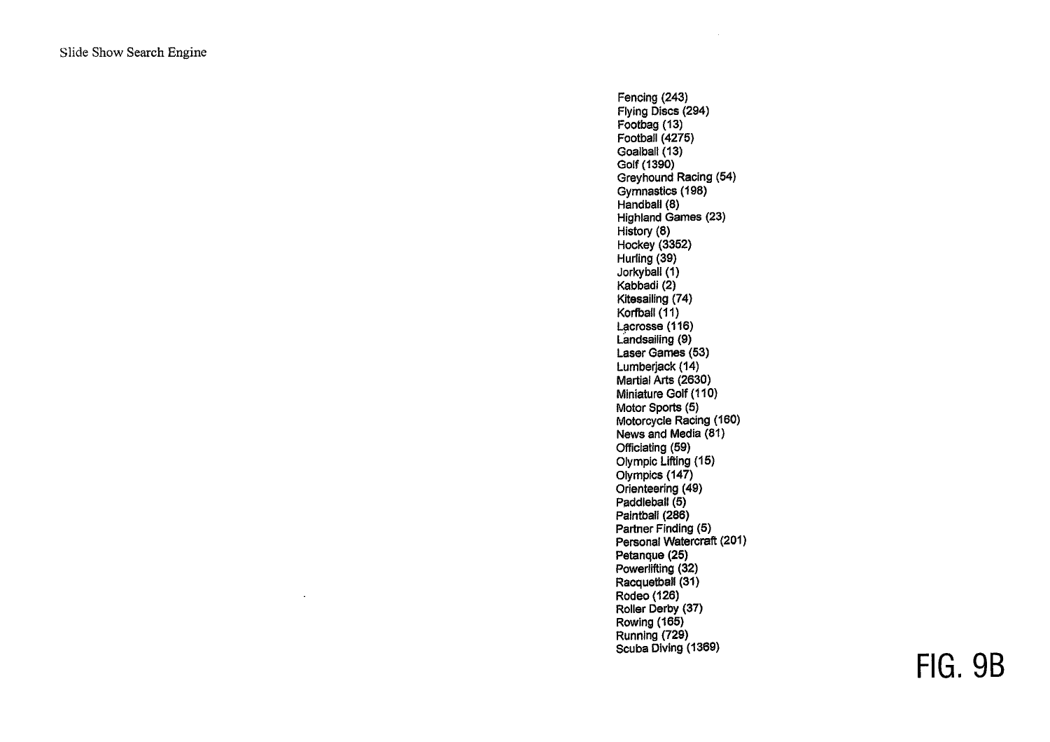

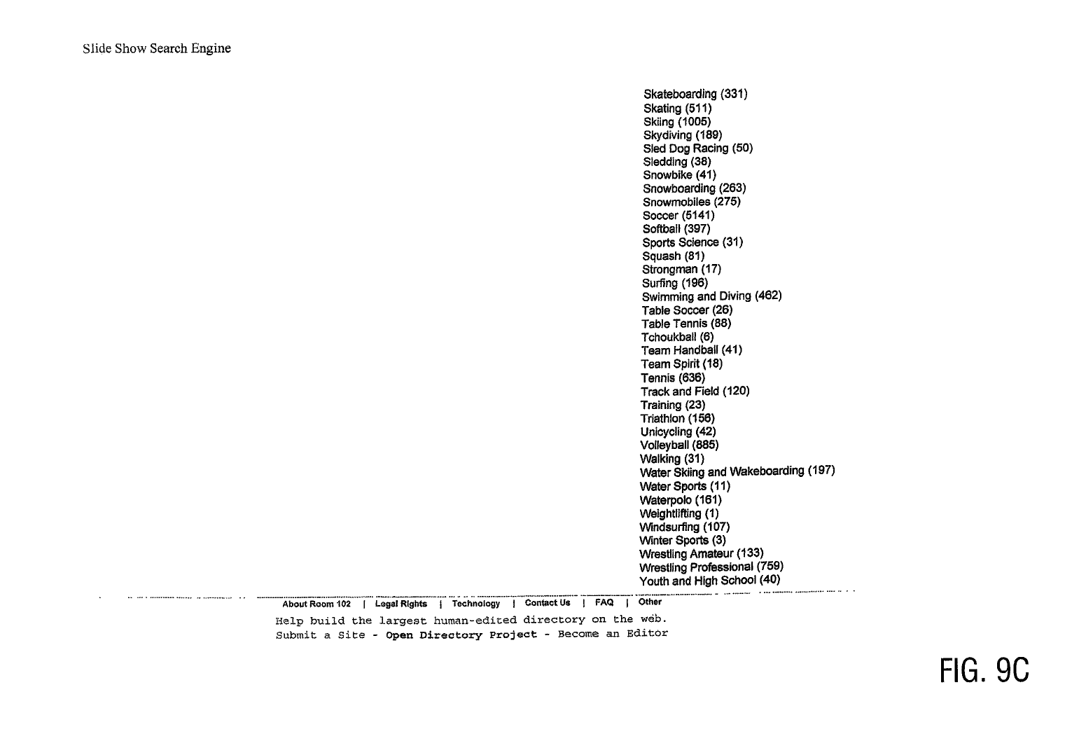

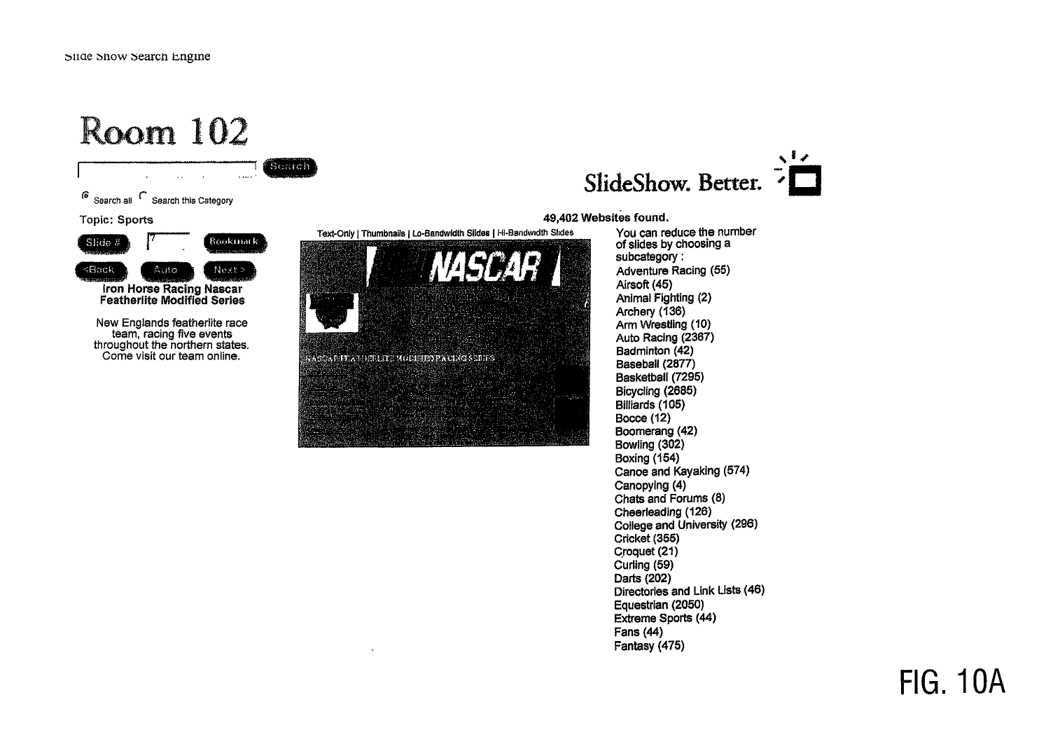

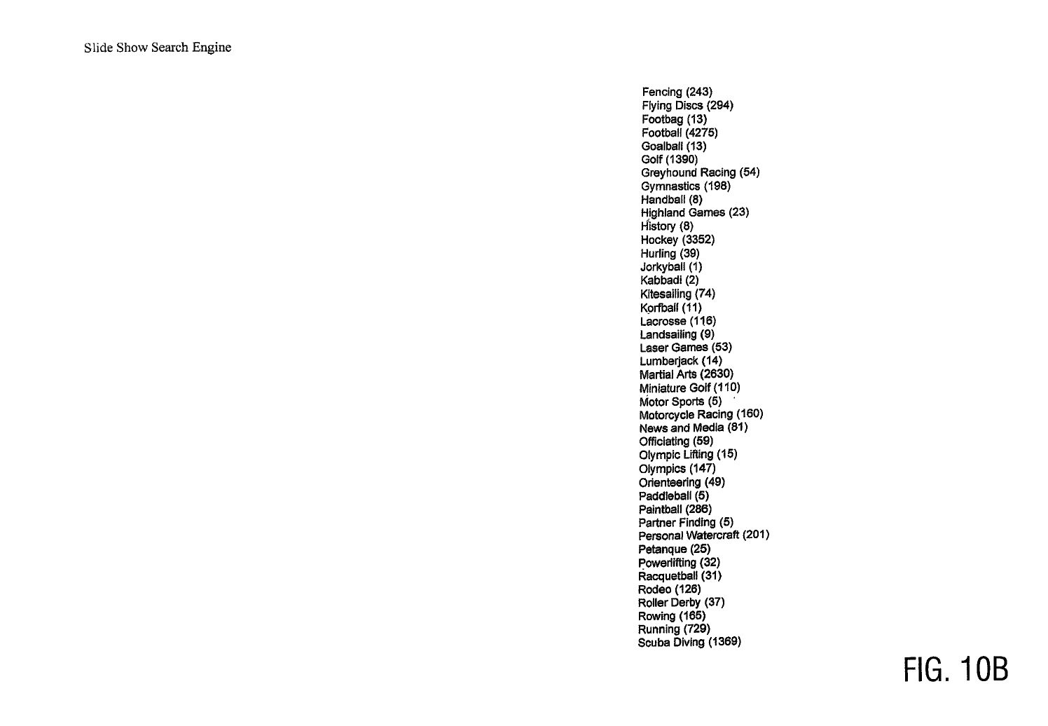

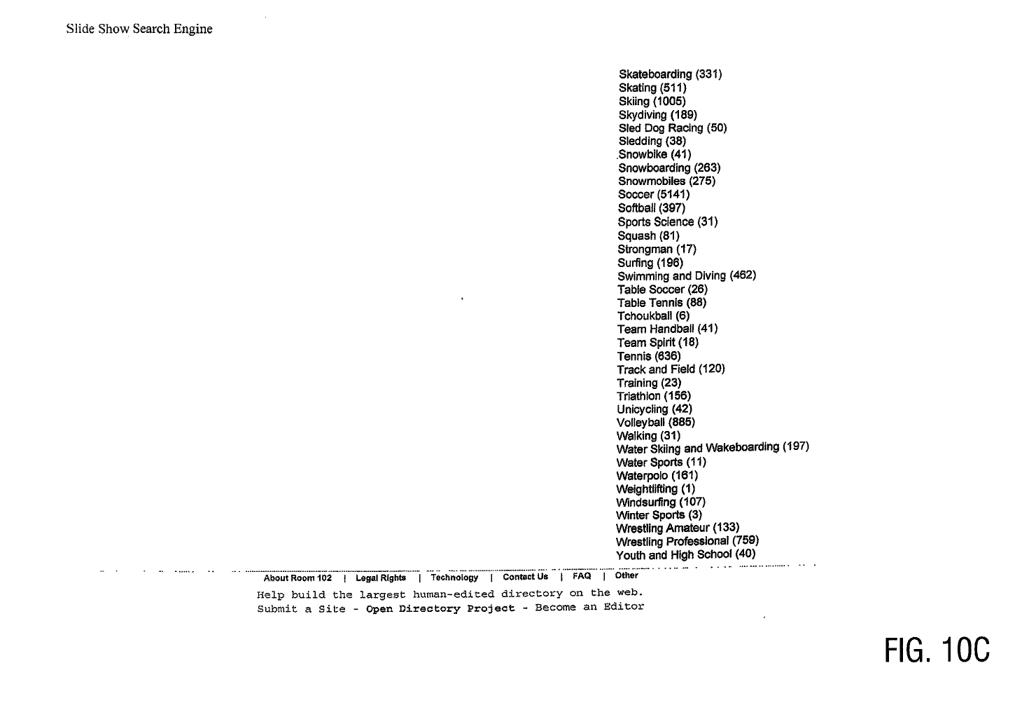

Referring to FIGS. 9 and 10, which are subsequent slides in the same “Sports” categorical search depicted in FIG. 8, FIG. 9 demonstrates the subsequent screen shot slide had the end user selected the “Next >” tab in the slide show controls of FIG. 8. From the size and details available in the screen shot image, users conducting this search can clearly see from the static homepage image that this specific website offers content regarding the PCTCC, or Pacific Coast Touring Car Championship. FIG. 10 offers the resultant screen shot slide located in the seventh position of the slide show in this specific categorical search. The end user could have proceeded to the screen shot in FIG. 10 by entering the number seven in the text box of FIG. 8 and selected the “Slide #” tab. FIG. 10's static homepage screen shot clearly identifies the Iron Horse Racing website, offering content on Nascar® racing. As FIGS. 9 and 10 demonstrate the illustrative nature of the slide show navigation embodied in the current invention, the figures also reveal that in a categorical search query, regardless of the number screen shot slide being reviewed in the series, end users always have the option to select on a specific subcategory or conduct a new categorical search by returning to Room102.com's homepage.

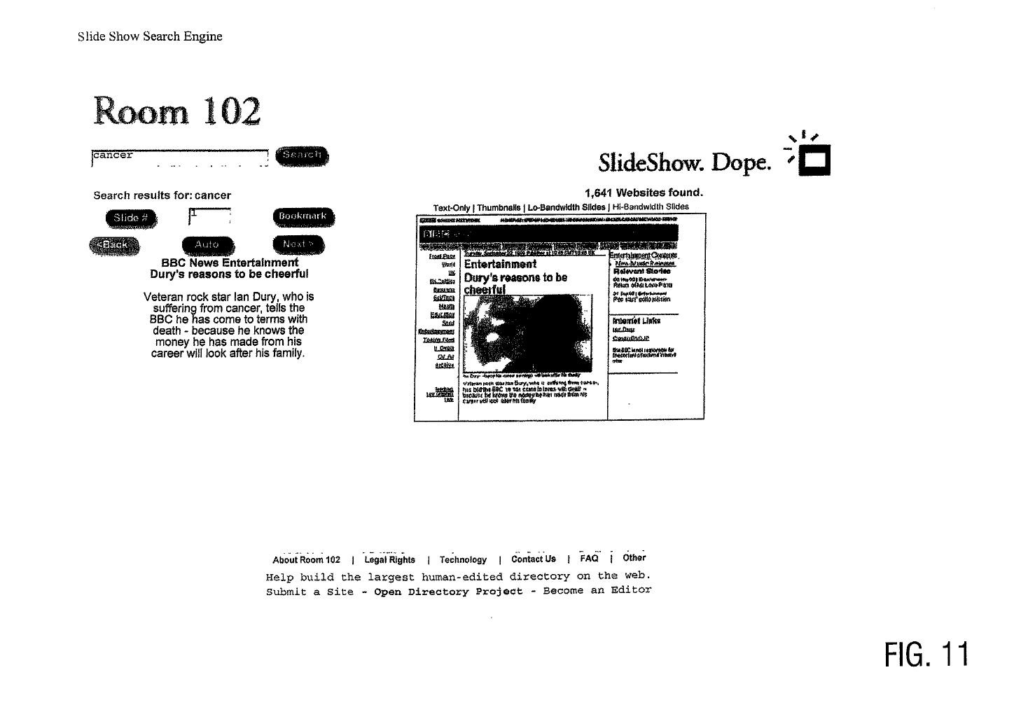

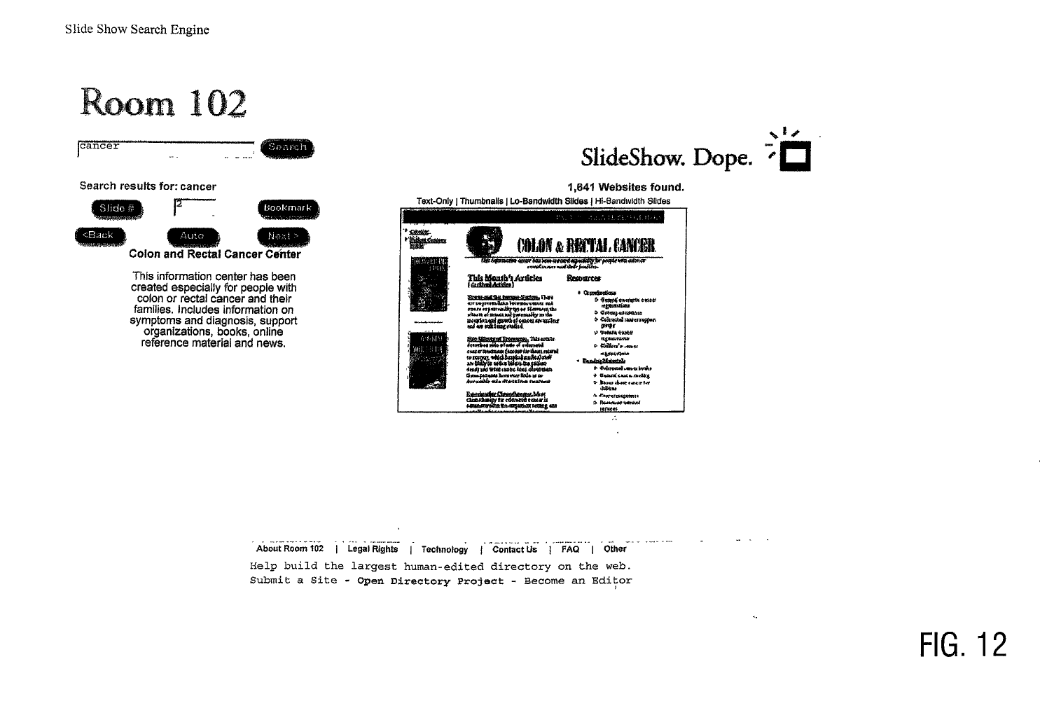

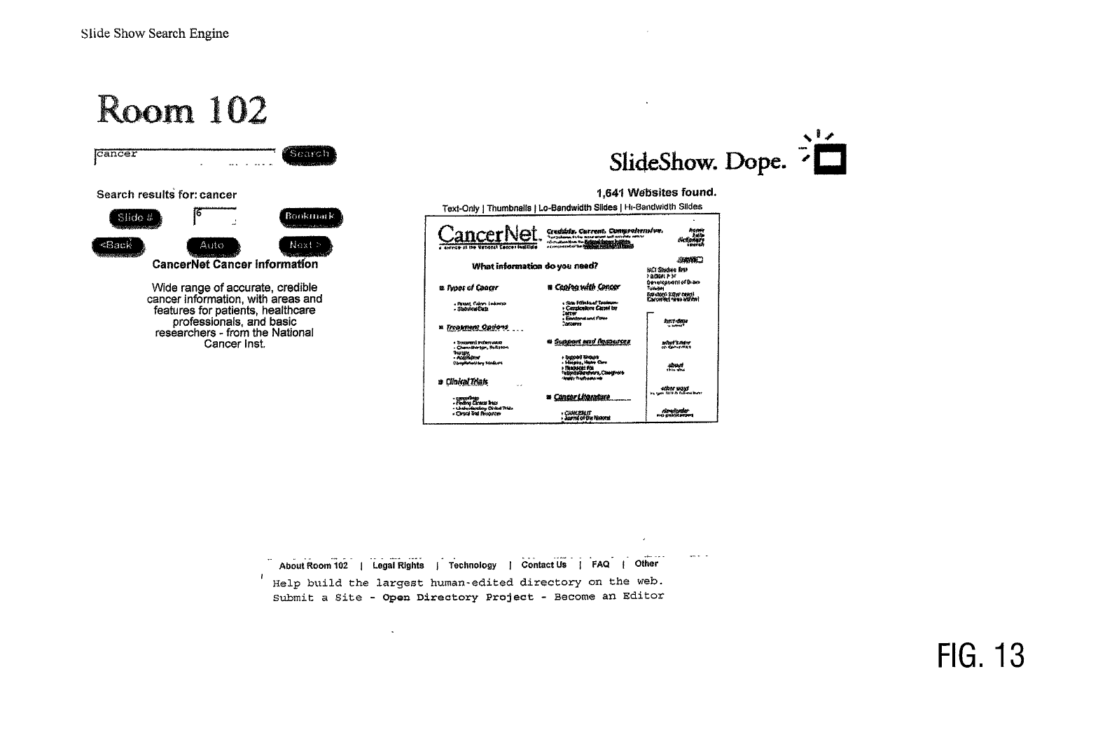

As an option to conducting categorical search queries in the preferred embodiment of the current invention, end users can also conduct a term or phrase specific graphical search query, as depicted in FIGS. 11 through 13. In this instance, a graphical search query was conducted under the term, “cancer.” FIG. 11 reveals the first screen shot slide matching the query term. FIG. 11's static homepage screen shot clearly displays the BBC News website with a central story on an entertainer, Dury; thus again offering a manner for Internet users to substantively review a website's homepage content prior to selecting the direct link to the website. As evidenced in FIG. 11, end users have the option to navigate the slide show similar to a categorical search as previously discussed. Should an end user select the “Next >” tab on FIG. 11, the current invention will present to the end user FIG. 12, the second slide in the slide show sequence matching a “cancer” term query. FIG. 12's static homepage screen shot reveals the Colon and Rectal Cancer website with its various articles and resource links. FIG. 13 portrays the sixth slide in the “cancer” slide show sequence for which the end user may have elected to proceed straight to by entering the number six in the text box of FIG. 11 and selected the “Slide #” tab. FIG. 13's static homepage screen shot reveals the CancerNet website and its various links such as Treatment Options, Coping with Cancer, and Cancer Literature.

Regardless of whether an Internet end user selects a categorical graphical search, as demonstrated with FIGS. 8 through 10, or a term specific graphical search, as demonstrated with FIGS. 11 through 13, if an end user is viewing a specific screen shot slide and wishes to link directly to the website depicted in the screen shot, the end user may link to the specific website by clicking the mouse over the screen shot image. Thereafter, the current invention's preferred embodiment will open an entirely new browser window in the end users' systems and download the linked website. The end user can then navigate the actual website in the new browser window in search of desired content. Because the current invention opens a new browser window, the Room102.com website is still open in the original browser on the end user system at the same slide as when the end user linked to a specific website. Thus, end users may return to the exact same slide being viewed prior to linking to an exterior website and continue with the same search query, conduct an new query or view previous slides within the same query. This functionality of the current invention removes the need to forward-link-backward-link so ubiquitously present in current search technology and substantially improves Internet search times.

Ultimately, from the perspective of the FEIT's functionality, the current invention's preferred embodiment offers Internet end users an improved manner to conduct Internet searches for information. The current invention's preferred embodiment allows end users to substantively and graphically review a website's homepage content to determine relevancy prior to actually linking to the website. This pre-audit of website homepages allows end users to only select the most desirous websites matching their preferences; and therefore, end users will save considerable time linking to unworthy websites, avoid various downloading annoyances like pop-ups and lengthy motion files, and avoid various breaches of their privacy and system's security. The current invention's preferred embodiment, therefore, enhances end users' overall experience with the Internet.

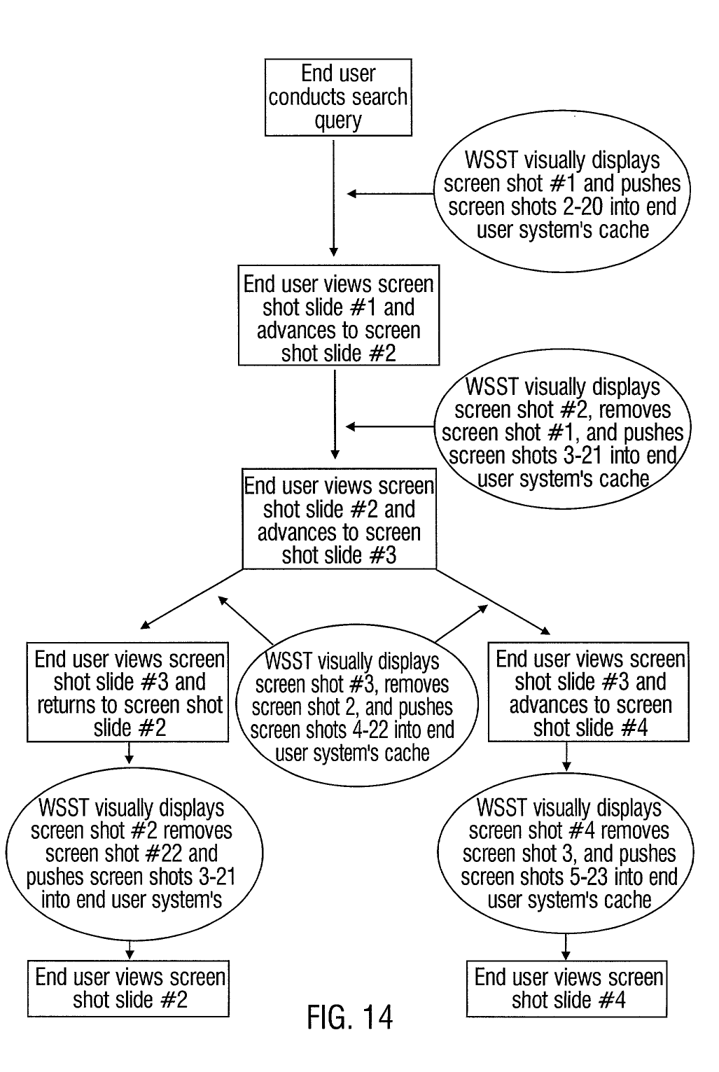

In addition to the end user interaction with the current invention's FEIT, the current invention's preferred embodiment contains code within the FEIT programming to further enhance Internet search experiences and reduce time consumption. The primary advantage in the current invention's method of reducing Internet search time is due to the compressed screen shot images, which allow for streamlined transmission of the screen shot image for downloading. However, in addition to the image compressions, the slide show technology also improves download time with each screen shot image the end user views. Referring to FIG. 14, after the end user has selected a categorical or term-based Internet query, the FEIT will present to the end user the first screen shot slide in the sequence of returned query matching screen shots. As the end user is viewing this primary slide, the current invention's preferred embodiment of the FEIT will push into the end user's system cache, or temporary video graphics memory, the next twenty screen shot slides in the sequence of the specific slideshow; thereby allowing an immediate presentation of the subsequent slides in the slideshow. As the end user sequentially moves forward in the slideshow, the current invention pushes more screen shots into the end user's cache and removes the earliest screen shot slide in the sequence on a one-to-one ratio. Thus, as the end user moves forward a slide, the FEIT removes from and adds to the end user's cache one slide. The current invention's FEIT will therefore effect a seamless and immediate slideshow display that drastically reduced downloading time for end users conducting a graphical Internet search.

V. Advertising with WSST

The current invention's preferred embodiment allows for improved methods for advertising over current models used in existing search engines. Referring to the slideshow images represented by FIGS. 6 through 13, the only variable images displayed with in the FEIT are the retrieved captured screen shot slides along with their corresponding descriptions. As the remainder of the display on the Internet end users' browser is static, the current invention can allow for interested commercial entities to place advertisements of their choosing within the surrounding static display of Room102.com. The static component of the current invention's preferred embodiment allows Room102.com to generate advertising revenue on the advertisements displayed on the static portion of the display according to variable factors, including, but not limited to, relevancy to the Internet search conducted, length of time displayed, number of times the advertisement is refreshed, and advertisement size. Pricing premiums may be generated on the more desirous advertising features of the static display component.

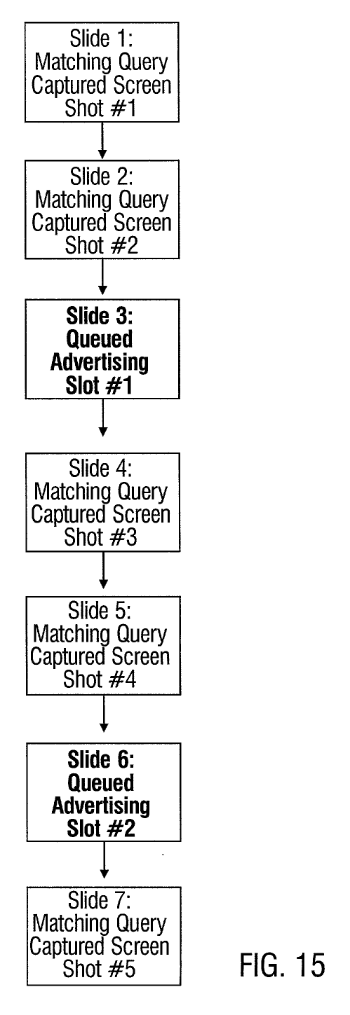

FIG. 15 demonstrates the manner in which the current invention's preferred embodiment allows for advertising revenue generation from the variable display within the FEIT—i.e. the slideshow itself. Immediately following an Internet search query using WSST, a list of relevant captured screen shot images is returned for display in a designated order in the slideshow. The current invention's preferred embodiment allows for interested commercial entities to purchase an advertisement slide or slot to be placed within the sequence of queued slides in the slideshow. According to this method, advertising revenue may be generated via pricing based on variable factors, including, but not limited to, relevancy to the search query, order of display within the slideshow sequence progression, length of time displayed, and number of reappearance times within the slideshow sequence progression. Premium pricing may be placed on the more desirable features within the slideshow sequence. In both the static and variable methods of generating advertising revenue, the current invention also may generate revenue for click-throughs of the displayed advertisements—i.e. when the Internet end user clicks on the advertisement within Room102.com to access the advertising company's website.

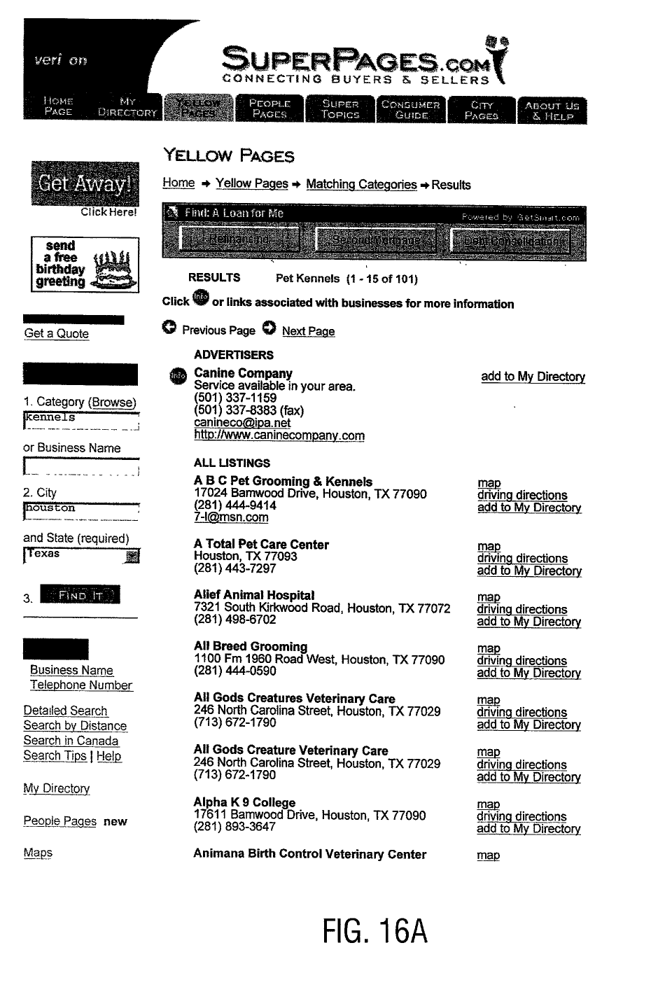

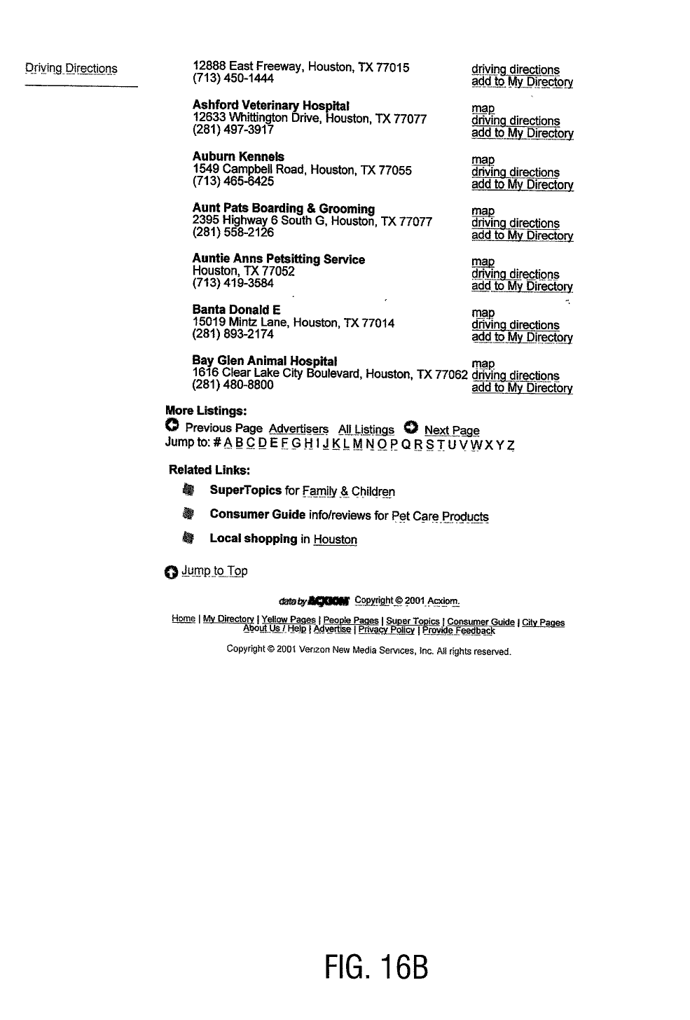

VI. Alternative FEIT's for the BET—The Enhanced Internet Business Directory (FIGS. 16 through 20)

FIG. 16 depicts the current website of a commercial Internet business directory, SuperPages.com. The specific text-based business listings presented, which are representative of typical current Internet business directories, are the result of a business search query for “kennels” in “Houston, Texas.” As displayed, these listings contain the companies' names in bold, their pertinent address and contact information, an occasional email address, and a hyperlink to a map or driving directions to get to the specific business listings' physical location. For a premium, a business can advertise a hyperlink to the specific business's Internet website for more information, in this case “Canine Company.” Clearly, the current format does not provide Internet users much substantive information regarding the individual businesses listed. Internet users are left to explore the merits of each company on their own prior to undertaking transactions with a specific business—a very unsatisfactory proposition for Internet users.

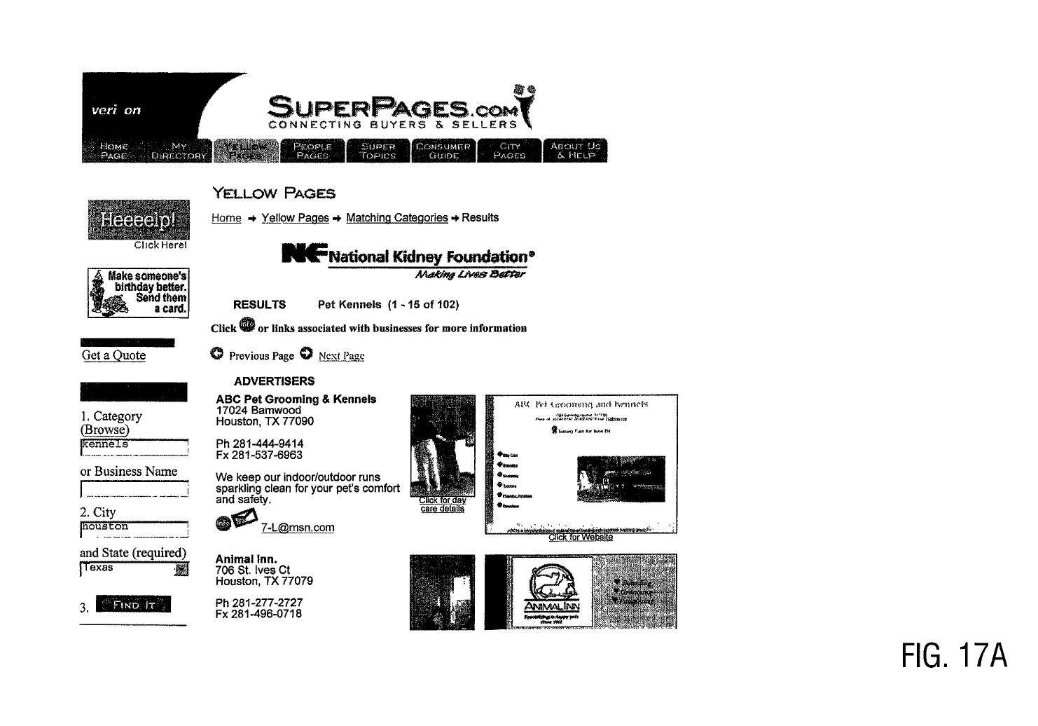

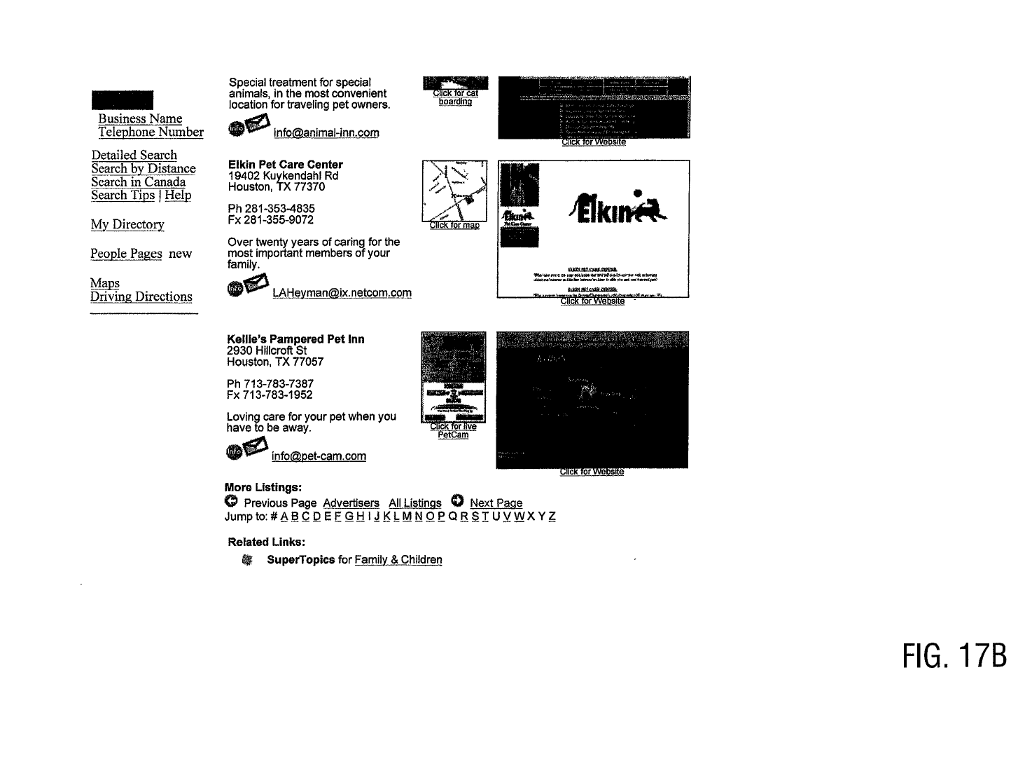

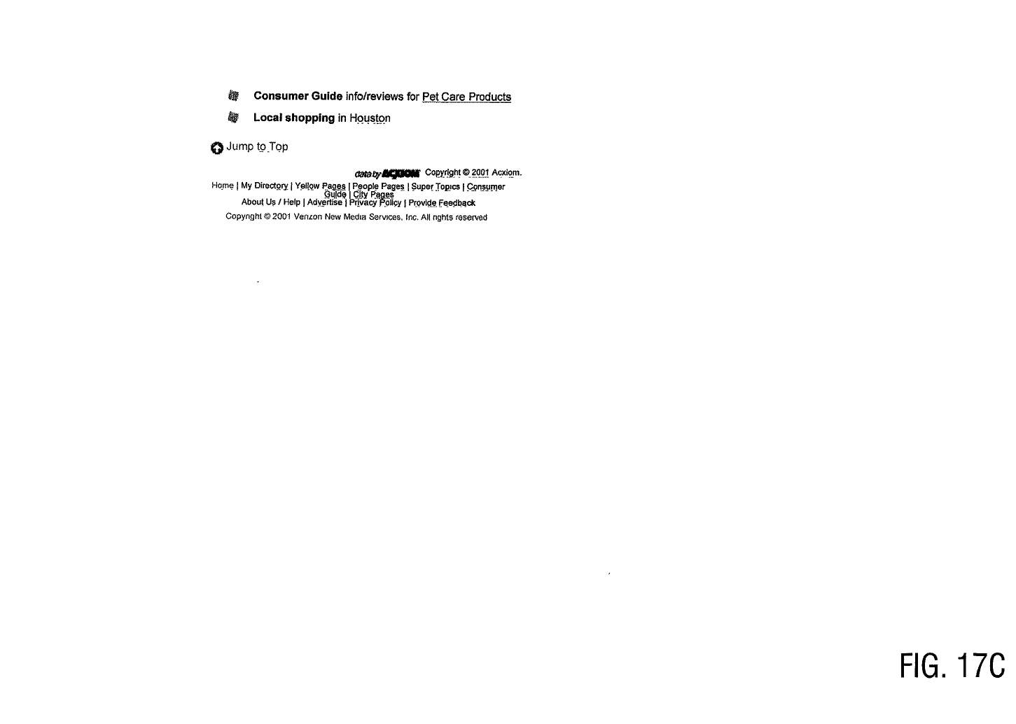

To address this problem and to provide Internet users a more substantive business directory query, the current invention's preferred embodiment offers a new and improved method for conducting Internet business directory searches, called the Enhanced Internet Business Directory (EIBD). The current invention's preferred embodiment utilizes its SSC technology and construction of a relational or graphics-based directory database to generate a database of captured images of businesses' homepages and other business-related images. Referring to FIG. 17, the current invention can then display these captured screenshot images alongside the Internet business listing. As demonstrated, businesses, for an advertising premium paid to the Internet business directory, can display a screenshot captured thumbnail of their homepage as well as another image containing information of their choosing, which may be a map, a sales special or discount, a product image, a catalogue page, a picture of management, or other pertinent information to the business. Both screenshots are click-through images, which the user can click with the mouse to go directly to the webpage or homepage depicted or any other linked file such as video, audio or other audiovisual programming. As compared to the traditional, strictly text-based format of current Internet business directories, the current invention's EIBD offers an improved and more substantive business directory from which Internet users can acquire more information and make an informed choice prior to initiating the transaction process.

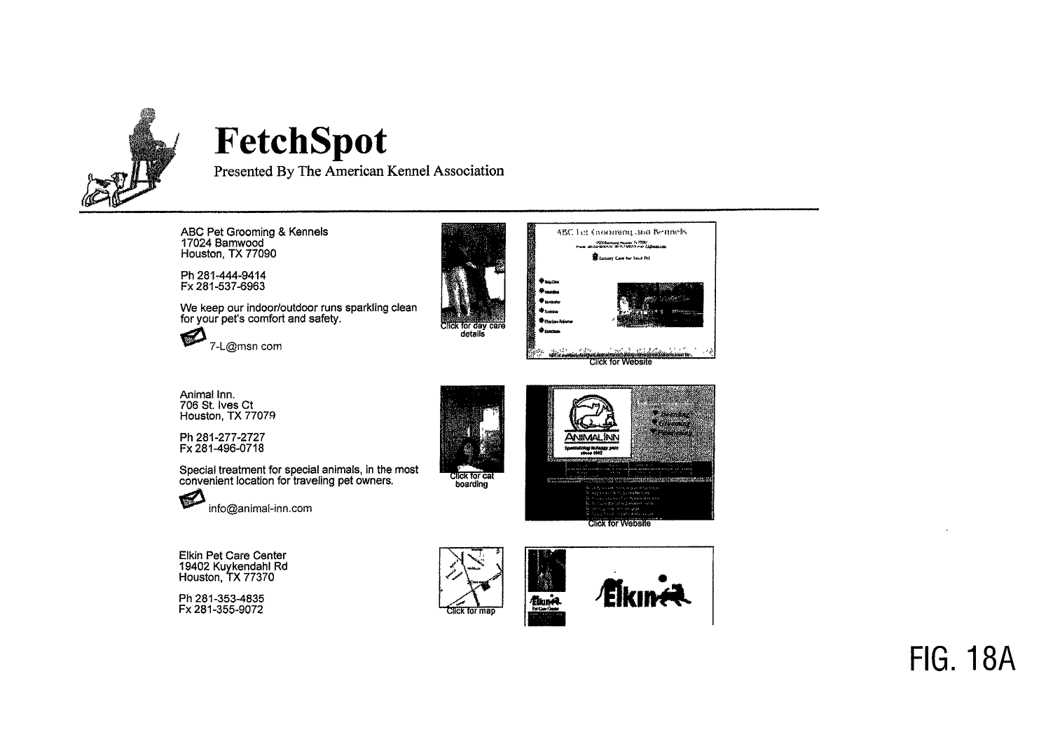

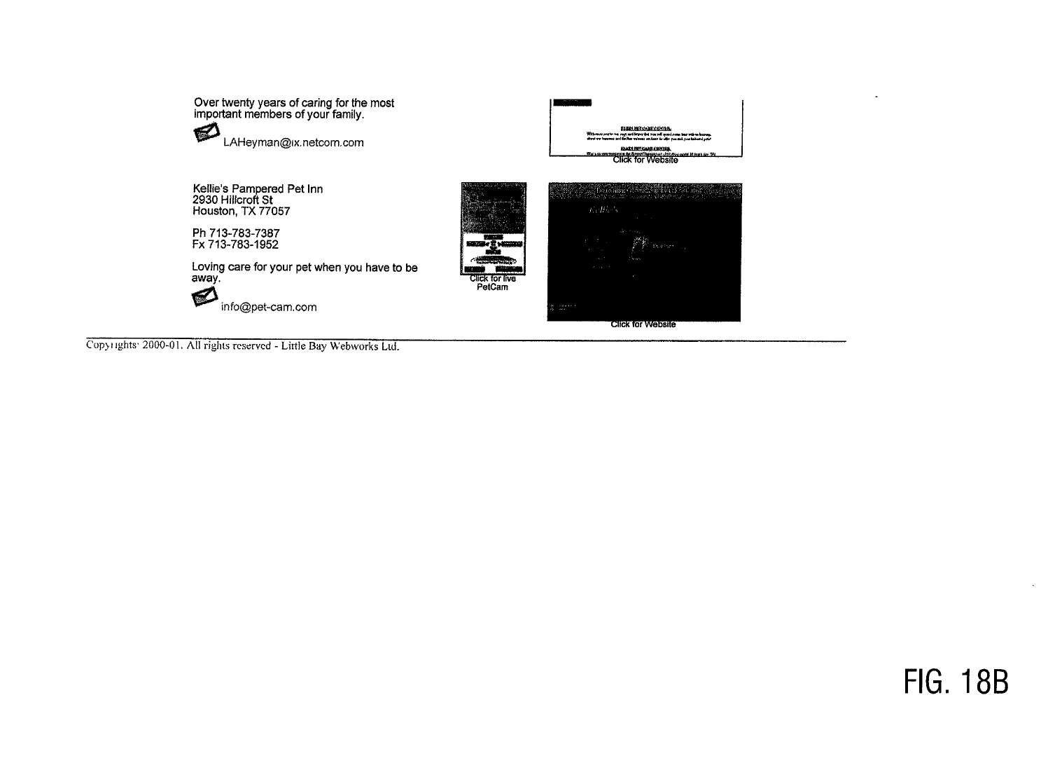

FIG. 18 demonstrates how the preferred embodiment of the current invention can also apply EIBD technology to industry associations. In this particular example, the American Kennel Association members have their business information listed alongside the captured screenshot images. A display as exemplified by FIGS. 17 or 18 clearly offers more information to Internet users and is more beneficial to businesses than the traditional text-based directory.

A. The Technology Behind EIBD

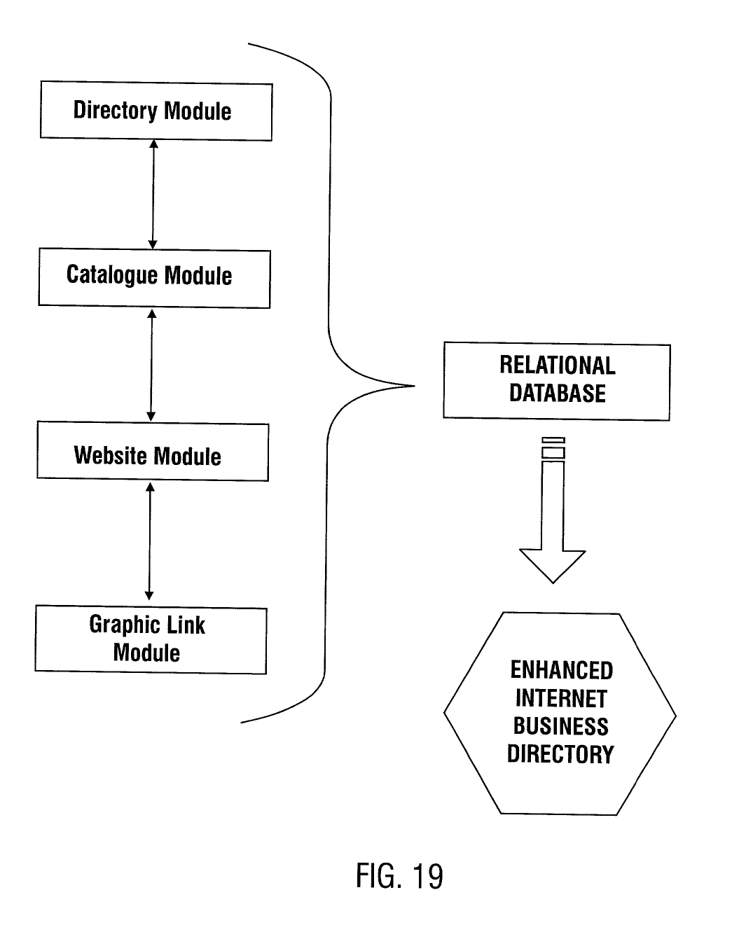

Referring to FIG. 19, the current invention's preferred embodiment constructs a relational or graphics-based database consisting of four modules of information. The Directory Module databases a collection of company names, addresses, telephone numbers, personnel information and other basic information. The Catalogue Module databases links and screenshot images to each company's full catalogue or brochure or other pertinent, business specific information in two format sizes. The first format size utilized consists of a link to the full-sized PDF or HTML image file of a company's catalogue or information used on the company's website. The second size consists of the faster-loading, reduced-size screenshot captured images that are displayed in the directory website. The Website Module databases an industry-specific Internet directory and search engine that utilizes the current invention's WSST. Finally, the Graphic Link Module databases an online collection of single pages, links or screenshots of promotional materials for the businesses. Each page, link, or screenshot provides a direct link to a corresponding webpage.

Although each module exists separately within the larger database architecture, each database module can be searched separately or in combination to produce the desired display on the business directory front-end interface. An Internet business directory search may be directed straight to a particular module. Alternatively, a search may be focused to a specific company's listing in the Directory Module, which will contain links to its Catalogue Module and/or its Website Module. Thus, each module contains links for specific companies that link to the companies' information in other modules. These links will, in the end result, be displayed within the directory website in the FEIT. Thus in combination, the relational database containing the four modules creates the infrastructure utilized in the current invention's EIBD.

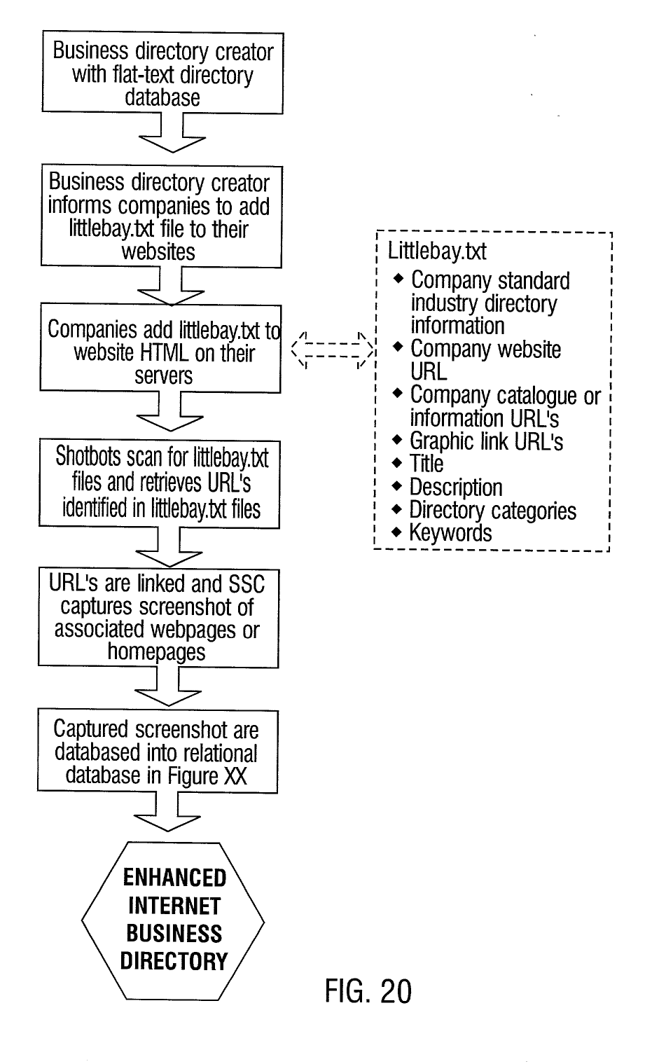

FIG. 20 depicts the current invention's preferred embodiment for the method by which the Internet business directory creator interacts with the current invention to create the end result of an EIBD. Referring to FIG. 20, the business directory creator creates a flat-text file directory database of businesses in their industry folders. Each listed business in the directory is informed to add a file to their individual websites, called littlebay.txt in the preferred embodiment. This littlebay.txt file is composed of entries containing individual companies' standard industry information, website URL, catalogue or other information URL's, and listing of each URL to a graphic link in the companies' website. The entries in the littlebay.txt file also contains four additional fields: title, description, directory categories, and keywords. Although the littlebay.txt file does not have a corresponding link displayed in the companies' websites, and is thus hidden from Internet users, the current invention accesses the littlebay.txt file in the companies' servers and HTML programming. Upon accessing the littlebay.txt file, the current invention's technology retrieves all the text-based information in the littlebay.txt file and utilizes shotbots to browse each of the URL's identified in the file. The shotbots retrieve the pages corresponding to these URL's, and the preferred embodiment deploys its SSC to take captured screenshots of these images to construct its database described from FIG. 19. For updating and editing, the process is repeated.

Thus, the preferred embodiment of the current invention also utilizes its core method for constructing WSST as well as creating an EIBD. Both applications employ the use of similar technologies in the back-end, primarily with the shotbots, screenshot capturing, and relational database construction, and in the bridging technology with the relational database. However, the applications differ in the FEIT by displaying a SlideShow with WSST contrasted to an Internet business directory with EIBD technology. Both modalities embodied by the current invention's preferred embodiment nevertheless provide an improved method for conducting searches on the Internet, whereby Internet end users can make more substantive and informed determinations regarding websites prior to actually connecting to the website.

To conclude, the present invention, as described, contains a method to function adeptly and successfully to achieve the objectives previously set forth and to provide the disclosed and inherent advantages over currently existing graphical and text-based Internet search technology. The preferred technology and components embodied in the current invention have been disclosed to enable complete invention functionality. Despite the disclosure of these preferred embodiments, changes in the detail of the current invention's construction may be involved as necessary to maintain the spirit of the invention and the scope of the application's claims as well as to satisfy suggestions of those skilled in the art.

What is claimed is:

1. A method for creating a database of Internet websites, the method comprising the steps of:
using a uniform resource locator (“URL”) to access an Internet website;
capturing a static image of the accessed Internet website; and
storing the URL and static image for the accessed Internet website in a database.

2. The method of claim 1, wherein the step of using a URL to access an Internet website comprises the step of launching a browser to send a scanning program to operate on the Internet.

3. The method of claim 2, further comprising the steps of automatically repeatedly sending a scanning program to operate on the Internet to obtain static images for a plurality of Internet websites.

4. The method of claim 1, wherein the step of capturing a static image of the accessed Internet website comprises the steps of:
using a browser to access the Internet website and provide a stored graphical image of screen display generated by the browser;
cropping the stored graphical image to create a static screen shot; and
storing said static screen shot as a graphics file.

5. The method of claim 4, wherein the step of storing said static screen shot as a graphics file comprises the step of compressing the static screen shot.

6. The method of claim 4, wherein the cropping step further comprises the step of removing undesirable text or graphic information from said information location.

7. The method of claim 1 wherein the step of storing the URL and static image for the accessed Internet website in a database includes the step of storing a timestamp corresponding to the time at which the static image of the accessed Internet website was captured.

8. A system for creating a database of graphical information corresponding to a plurality of Internet websites, the system comprising:
at least one shotbot that utilizes a list of uniform resource locators (“URLs”) to access Internet websites corresponding to the URLs, the shotbot including means for obtaining a static graphics file corresponding to at least some of the accessed Internet websites; and
means for assembling the URLs and the graphics files corresponding to the accessed Internet websites into a relational database, the relational database including a partitioned URL table including the URLs and the static graphics files for at least some of the accessed Internet websites.

9. The system of claim 8 wherein the means for assembling includes means for storing, for each URL in the relational database information, information corresponding to the size of the static graphics file associated with the URL.

10. The system of claim 8 wherein the means for assembling is such that each URL appears in the relational database only a single time.

11. The system of claim 8 wherein the means for assembling is such that the relational database lists, for each stored URL, information concerning the content of the Internet website associated with the URL.

12. The system of claim 8 further including means for accessing the relational database in response to user-input search queries.

13. The system of claim 12 wherein the means for accessing receives the user-input search queries and provides, in response, the static graphic files that are associated in the relational database with URLs related to the search-query.

14. The system of claim 13 wherein the static graphics files are provided in a slideshow format.

15. A method of presenting advertising and searchable graphical information to a user, the method comprising the steps of:
providing a database containing a plurality of data entries, each data entry containing: (a) a static graphics file containing graphical information representing a static image associated with an Internet website; and (b) information concerning the content of the Internet website associated with the Internet website;
receiving a user-entered query;
searching the database to identify entries having content information related to the query; and
providing to the user the static graphic files corresponding to the identified entries in a slideshow format with the static graphics files being arranged in a queue; and
inserting into the queue of static graphic files one or more advertising slides.

16. The method of claim 15 further comprising the step of selecting the advertising slide based upon the user-entered query.

17. The method of claim 15 further comprising the step of calculating a charge for the placement of an advertising slide into the queue

18. The method of claim 16 wherein the charge varies depending on the location of the placement of the advertising slide.

19. The method of claim 16 wherein the step of presenting the identified entries in a slideshow format includes the step of presenting the entries within a static frame.

20. The method of claim 19 further comprising the step of presenting advertising information in the static frame and changing the advertising information in the static frame after a preselected number of slides have been reviewed by the user.
